(19) United States
(12) Patent Application Publication
(10) Pub. No.: US 2006/0104582 A1
(43) Pub. Date: May 18, 2006

(54) Fabrication of microstructured optical fibre

(76) Inventors: Kenneth Edward Frampton, Hampshire (GB); Daniel William Hewak, Hampshire (GB); Kai Ming Kiang, Hampshire (GB); Tanya Mary Monro, Hampshire (GB); Roger Charles Moore, Hampshire (GB); David John Richardson, Hampshire (GB); Harvey Rutt, Hampshire (GB); John Anthony Tucknott, Hampshire (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/507,278

(22) PCT Filed: Mar. 6, 2003
(86) PCT No.: PCT/GB03/00942

§ 371 Date: Dec. 9, 2005

(30) Foreign Application Priority Data
Mar. 13, 2002 (GB) 0205905.3

(51) Int. Cl. G02B 6/02

(52) U.S. Cl. 385/123; 385/125

(57) ABSTRACT

Microstructured optical fibre is fabricated using extrusion. The main design of optical fibre has a core suspended in an outer wall by a plurality of struts. A specially designed extruder die is used which comprises a central feed channel, flow diversion channels arranged to divert material radially outwards into a welding chamber formed within the die, a core forming conduit arranged to receive material by direct onward passage from the central feed channel, and a nozzle having an outer part in flow communication with the welding chamber and an inner part in flow communication with the core forming conduit, to respectively define an outer wall and core of the preform. With this design a relatively thick outer wall can be combined with thin struts (to ensure extinction of the optical mode field) and a core of any desired diameter or other thickness dimension in the case of non-circular cores. As well as glass, the extrusion process is suitable for use with polymers. The microstructured optical fibre is considered to have many potential device applications, in particular for non-linear devices, lasers and amplifiers.

### BACKGROUND OF THE INVENTION

The invention relates to optical fibre, more particularly to a process for fabricating microstructured optical fibre, its preforms, to microstructured optical fibre made using the process and to devices incorporating microstructured optical fibre.

Microstructured optical fibre, also frequently referred to in the art as holey fibre or photonic crystal fibre, is the subject of intensive research and development.

To date, microstructured optical fibre has been manufactured by a capillary stacking process. A number of circular section rods are stacked together inside a jacket and drawn or “caned” into a preform. The preform is then drawn again into the microstructured optical fibre.

FIG. 1 of the accompanying drawings is a schematic section of a conventional microstructured fibre preform. A core rod 10 (shown as solid, but may be hollow) is surrounded by at least one ring of hollow cladding capillary tubes 12 (two rings in the figure) which in turn is enclosed in an outer jacket 14 (illustrated as thick-walled, but may be thin-walled). The initial assembly of stacked tubes and/or rod(s) from which the preform is drawn will have outer dimensions of the cm scale. In the preform, i.e. after the initial drawing step, the inner diameter of the jacket may be typically of the order of 1 mm. After drawing of the fibre, these dimensions typically reduce by around 2-3 orders of magnitude.

FIG. 2 is a cross-sectional micrograph of an example microstructured fibre made from a preform generally as shown in FIG. 1, but with four rings of hollow cladding capillary tubes, rather than two. The large residual holes are formed by the hollow parts of the capillary tubes. The small residual holes are formed from the three-cornered gaps formed between the capillary tubes and core rod.

While successful, the capillary tube stacking process has been criticised.

Ian Maxwell [1] points out that, because capillary tubes and rods can be stacked only in a few ways, they restrict the manufacturing process and limit the type of structures that can be fashioned. Essentially, tubes and rods stack in a tessellating arrangement, usually hexagonally close packed, which dictates what microstructures are achievable. As well as hexagonal close packing, square grid packing has also been demonstrated.

Another issue with the capillary tube stacking process is that there are a large number of air-glass surfaces which may be problematic in that there is a tendency for impurity incorporation and also propagation of surface structural defects, such as scratches and pits, during fabrication. It may thus be difficult to apply the capillary tube stacking process on an industrial scale, at least without full clean room conditions.

Another significant problem with capillary stacking is that variance in the outer diameter of the capillaries (or rods) must be kept low, not only from capillary to capillary, but also along the length of each capillary. If the variance is not controlled, the stacking faults will arise.

FIG. 3 shows the structure of a proposed microstructured optical fibre in cross-section. The structure has a circular-section core 20 of diameter ‘d’ suspended concentrically in a circular outer wall 22 by a plurality of thin webs or struts 24 that extend along the length of the fibre as membranes. The core diameter ‘d’ is sufficiently large to support optical mode guidance. The strut thicknesses and lengths are sufficiently small and long respectively to ensure that the struts do not support an optical mode. In other words the struts are dimensioned so that there is evanescent mode field decay in the struts. This design ensures that the struts do not influence the coarser properties of the mode guidance in the core which is thus effectively air suspended.

FIG. 4 shows in section the form of an optical fibre made according to Kaiser & Astle [2] in which a rod 30 is arranged on a plate 32 embedded in a cladding tube 34 in order to fabricate a multimode optical fibre.

The idealised structure of FIG. 3 is not compatible with usual capillary stacking approach to fabricating microstructured optical fibres. The inventors have however realised that this kind of structure is in principle of a form that might be manufacturable using extrusion.

Extrusion, in the form of disc extrusion, is a known technique for manufacturing conventional optical fibre and is now briefly described for background.

FIG. 5 is a schematic drawing illustrating disc extrusion for fabricating conventional optical fibre. A disc 40 of core glass is arranged on top of a disc 42 of cladding glass in the upper part of an extruder die 44. The glass is then subject to downward pressure (indicated by the arrow), applied by a punch or ram which forces the glass through a circular tapered aperture formed in the lower part of the extruder die. As a result a rod is formed with the core glass radially inwardly disposed of the cladding glass. The rod is then used to draw a conventional optical fibre.

FIG. 6 shows a section through the tapered rod in which the core glass is formed into a circular section core 46 and the cladding glass surrounds it to form cladding 48.

In the general field of glass forming, extrusion has been used to make complicated glass structures, specifically for making thermometers. Roeder & Egel-Hess [3] describe extrusion of complicated glass structures.

FIG. 7 is a section drawing reproduced from Roeder & Egel-Hess showing an extruder die 70 used to make a tube. The Roeder & Egel-Hess extruder die 70 comprises a main body 72 which holds a die 74, a funnel part 76 and a spider 80. A mandrel 78 is attached to the spider 80 by a fixing 84. A second fixing 86 holds the main body 72, the die 74, the funnel part 76 and the spider 80 together. A cap 82 is attached to the main body 72 as indicated in FIG. 7. The spider 80 defines three channels 88a, 88b, 88c in fluid communication with a welding chamber 90 defined by the mandrel 78 and the funnel part 76. In operation, glass is held within the cap region 82 and urged through the channels 88a, 88b, 88c in the spider 80 under the application of an external force in the direction indicated by the arrow. The glass is split into three streams by the spider 80. These streams recombine within the welding chamber 90 to form a single rope, the angled walls of the funnel part 76 assist this process by concentrating the material. The die 74 and mandrel 78 together define a cylindrical section 92 through which the glass within the funnel part 76 is pushed The resulting extruded glass has a circular ring cross-section defined by the geometry of the cylindrical section 92.

FIGS. 8a-8d are perspective views of more complicated glass structures successfully fabricated by Roeder & Egel-Hess in which a core is effectively suspended by a plurality of struts inside an outer wall. Although these glass structures do not appear to have been made using an extruder die as shown in FIG. 7, which is designed for extruding simple tubes, perhaps the extruder dies used to make these more complex structures were in some way modified versions of the extruder die designs described in the article Roeder & Egel-Hess.

Special considerations arise for microstructured optical fibre fabrication which were not relevant to the general work of Roeder & Egel-Hess that was not concerned with optical fibre fabrication, but rather thermometer glass structures.

For microstructured optical fibre fabrication the following considerations need to be taken account of

optical design considerations dictate that the extrusion process should allow the wall thicknesses of the struts to be several times thinner than the core diameter so that optical mode extinction can be ensured;

fabrication considerations dictate that the extrusion process should allow for the outer walls to be relatively thick, meaning that the outer wall thickness is several times thicker than the thicknesses of the struts;

the optical quality of the core glass is paramount; and

surface quality of the core glass, and of surrounding glass where the mode field has significant power, is paramount.

The first two design considerations although apparently modest do in fact present considerable difficulty for a glass maker familiar with extrusion. One of the major principles of extruder die design is that all wall thicknesses should be the same. This is in order to ensure that the glass is forced out of the end aperture of the die uniformly across the required die pattern. Surface friction in the die means that any variation in die aperture dimension will result in differential glass flow across the die. The general rule is to avoid any such complications in order to preserve integrity of the extrusion process.

The third design consideration is also not compatible with conventional die designs, since the glass that ultimately forms the core is not specially treated by the die.

The fourth design consideration is considered to be novel altogether, since it is not relevant to extrusion of thermometer structures or conventional optical fibre.

It is therefore an aim of the invention to fabricate microstructured optical fibre and preforms by extrusion to allow novel microstructures to be achieved that cannot be made with conventional capillary stacking methods.

### SUMMARY OF THE INVENTION

According to a first aspect of the invention there is provided an extruder die for forming a preform for manufacture into an optical fibre, comprising: a central feed channel for receiving a material supply by pressure-induced fluid flow; flow diversion channels arranged to divert a first component of the material radially outwards into a welding chamber formed within the die; a core forming conduit arranged to receive a second component of the material from the central feed channel that has continued its onward flow; and a nozzle having an outer part in flow communication with the welding chamber and an inner part in flow communication with the core forming conduit, to respectively define an outer wall and core of the preform.

With this novel die design the multiple requirements for extruding preform shapes required for microstructured optical fibres can be satisfied. In particular, material feed through a central feed channel followed by subsequent diversion of part of the material to fill a welding chamber and continuation of another part of the material to form the central core, allows a high optical quality core to be formed with very smooth surfaces in the core region while at the same time allowing a thick outer wall to be made in combination with thin supporting struts.

It is considered that the above-specified requirements cannot be met satisfactorily with a conventional die design in which the material is forced radially inwardly from a conventional spider feed into a central axial region.

As detailed in the following, the use of extrusion to produce a microstructured preform has been demonstrated. The preform has been caned and drawn into a microstructured optical fibre which is capable of single-moded light guidance over a broad range of wavelengths. The disclosed die design allows extrusion to be used to produce complex structured preforms with good surface quality, and makes efficient use of raw materials. By avoiding capillary stacking, fewer interfaces are involved, and so ultimately extrusion may offer lower losses than existing techniques. In addition, extrusion can be used to produce structures that could not be created with capillary stacking approaches, and so a significantly broader range of properties should be accessible in extruded microstructured fibres. Single-material fibre designs avoid core/cladding interface problems, and so should potentially allow low-loss fibres to be drawn from a wide range of glasses and polymers.

The extruder die may be provided with pairs of mutually facing internal walls that form gaps extending between the core forming conduit and the welding chamber and allow fluid communication therebetween, the gaps being shaped to form struts supporting the core in the outer wall.

The mutually facing internal walls may incorporate at least one bend in order to increase the radial length of the struts. This is useful to counteract the effects of surface tension when the preform is reduced by caning and/or drawing. The mutually facing internal walls may extend parallel to each other for a part or the whole of their extent or may be tapered either in the principal flow direction or in a perpendicular plane thereto.

The internal walls may have a radial length greater than the gap width. The radial length of the internal walls is greater than the gap width by a factor of one of: 2, 3, 4, 5, 6, 7, 8, 9, 10 and 20.

In some embodiments, the outer part of the nozzle is shaped to provide a circular-section preform outer wall.

In other embodiments, the outer part of the nozzle deviates from a circular shape so as to provide sections of preform wall interconnecting wall-to-strut junctions that are shorter than would be required to form a circular-section preform outer wall. This is useful to counteract the effects of surface tension when the preform is reduced by caning and/or drawing and may be advantageously combined with the above-mentioned bends in the internal walls.

The outer part of the nozzle preferably has a first dimension defining a wall thickness of the preform outer wall and wherein said first dimension is greater than said gap between the mutually facing internal walls that form the preform struts. In examples, said first dimension is greater than said gap by a factor of one of: 2, 3, 4, 5, 6, 7, 8, 9 and 10.

The inner part of the nozzle preferably has a second dimension defining a core thickness of the preform core and wherein said second dimension is greater than said gap between the mutually facing internal walls that form the preform struts. In examples, said second dimension is greater than said gap by a factor of one of: 2, 3, 4, 5, 6, 7, 8, 9 and 10.

The flow diversion channels may include a first group of the flow diversion channels which extend from the core forming conduit to the welding chamber. The flow diversion channels of the first group extend perpendicular to the core forming conduit in one example. The flow diversion channels of the first group may have a width dimension that is substantially constant in the feed direction or a width dimension that reduces in the feed direction.

The flow diversion channels may also include a second group of the flow diversion channels that extend from the central feed channel to the welding chamber. In an example, the flow diversion channels of the second group extend obliquely to the central feed channel, for example at an angle of 30-60 degrees relative to the extrusion direction.

The die may also be adapted to allow fabrication of hollow core fibre. This can be achieved by providing the die with a mandrel extending down the central feed channel into the core forming conduit with a dependent peg thereof so as to form a hollow core in the preform.

The central feed channel is advantageously connected to the core forming conduit by a taper, thereby to ensure smooth feed of material.

According to a second aspect of the invention there is provided an extruder apparatus including a main body having a location for receiving an extruder die according to the first aspect of the invention, a space for arranging a billet of material above the extruder die and a force transmitting assembly for applying pressure to the billet to drive the material through the extruder die.

According to a third aspect of the invention there is provided a method of forming a preform for manufacture into an optical fibre, comprising:

applying pressure to supply a material into a central feed channel of an extruder die by pressure-induced fluid flow;

diverting a first component of the material radially outwards into a welding chamber formed within the die;

allowing a second component of the material to flow onwards from the central feed channel into a core forming conduit in the die; and

dispensing the material through a nozzle having an outer part in flow communication with the welding chamber and an inner part in flow communication with the core forming conduit, to respectively define an outer wall and core of the preform.

The method may use any of the die alternatives described in relation to the first aspect of the invention.

The material supplied to the central feed channel can be a glass or polymer. Other materials may also be contemplated.

According to a fourth aspect of the invention there is provided a method of manufacturing an optical fibre comprising: forming a preform by extrusion according to the method of the third aspect of the invention; and reducing the preform to an optical fibre.

In some embodiments, reducing the preform to an optical fibre comprises reducing the preform to a cane followed by reducing the cane to the optical fibre. In that case, the preform generated directly by the extruder die can be termed a cane preform. Reducing the cane may comprise arranging the cane in a tubular jacket and reducing the cane and tubular jacket into the optical fibre. The cane and tubular jacket may then be referred to as a fibre preform. As an alternative to arranging the cane in a tubular jacket, reducing the cane may comprise arranging the cane amongst a plurality of rods and/or tubes to form a stack and reducing the stack into the optical fibre.

In other embodiments, the optical fibre may be drawn directly from the preform generated by the extruder die, in which case the preform generated directly by the extruder die will be a fibre preform (not a cane preform).

According to a fifth aspect of the invention there is provided a preform for manufacture into an optical fibre made using the method of the third aspect of the invention.

According to a sixth aspect of the invention there is provided an optical fibre made using the method of the fourth aspect of the invention.

According to a seventh aspect of the invention there is provided a preform for manufacture into an optical fibre, comprising a core suspended in an outer wall by a plurality of struts.

The struts may have a width dimension smaller than a width dimension of at least one of the outer wall and the core by a factor of at least two. In examples, the factor is at least one of 3, 4, 5, 6, 7, 8, 9 and 10. The struts may incorporate at least one bend in order to increase their radial length. The wall as viewed in cross-section may deviate from a circular shape so as to provide wall sections interconnecting wall-to-strut junctions that are shorter than would be required to form a circular-section outer wall. The core may have a thickness that varies along its axial extent. The struts may extend helically. The preform may include at least one further core. The preform may include at least one integral electrode. The struts may have a width and a radial length and the radial length is greater than the width. In examples, the radial length of the struts is greater than the width by a factor of one of: 2, 3, 4, 5, 6, 7, 8, 9, 10 and 20. The preform may be made of a glass material, a polymer material, including a mixture of glass and polymer, such as polymer outer regions and glass central regions, including the core.

According to an eighth aspect of the invention there is provided an optical fibre comprising a core suspended in an outer wall by a plurality of struts.

The struts may have a width dimension smaller than a width dimension of at least one of the outer wall and the core by a factor of at least two. In examples, the factor is at least one of 3, 4, 5, 6, 7, 8, 9 and 10.

The core may have a thickness that varies along its axial extent. The fibre may include at least one further core, for example two cores, three cores, four cores or a higher number of cores. The struts may extend helically. The fibre may include at least one integral electrode. The electrode material may be incorporated during extrusion, or during subsequent caning or drawing, or after drawing.

The struts may have a radial length greater than at least one of 2, 3, 4, 5, 6, 7, 8, 9, 10, 12, 14, 16, 18 and 20 micrometers.

The struts may have a width smaller than the radial length of the struts by a factor of at least one of 2, 3, 4, 5, 6, 7, 8, 9, 10, 12, 14, 16, 18 and 20.

The optical fibre may be made of a glass material or a polymer material, including a mixture of both.

The core width may be greater than at least one of: 0.3, 0.5, 1, 2, 3, 4, 5, 6, 7, 8, 9, 10, 12, 14, 16, 18 and 20 micrometers.

The core may be solid or hollow.

According to a ninth aspect of the invention there is provided a method of manufacturing a microstructured optical fibre comprising: forming by extrusion a preform comprising a core suspended in an outer wall by a plurality of struts; and reducing the preform into an optical fibre.

According to a tenth aspect of the invention there is provided a laser, amplifier, non-linear device, switch, acousto-optic, sensor or other optical device comprising optical fibre according to the eighth aspect of the invention. Other devices can also be made, as described in more detail further below.

### BRIEF DESCRIPTION OF THE DRAWINGS

For a better understanding of the invention and to show how the same may be carried into effect reference is now made by way of example to the accompanying drawings in which:

FIG. 1 shows in schematic cross-section a capillary stacked optical fibre cane preform of the prior art;

FIG. 2 is a cross-sectional micrograph of an example prior art microstructured fibre made from a cane preform generally as shown in FIG. 1;

FIG. 3 shows in schematic cross-section an idealised microstructured optical fibre;

FIG. 4 shows in schematic cross-section an optical fibre made according to Kaiser & Astle [2];

FIG. 5 shows in schematic cross-section a disc extruder of the prior art for making conventional optical fibre;

FIG. 6 shows in schematic cross-section a conventional optical fibre made using disc extrusion;

FIG. 7 schematically shows an extruder die used by Roeder & Egel-Hess [3] to make a glass tube;

FIGS. 8a-d show schematic perspective views of glass structures fabricated by Roeder & Egel-Hess [3];

FIG. 9a shows in schematic cross-section an extruder die according to one embodiment of the invention;

FIG. 9b shows in schematic cross-section an outer die part of the extruder die shown in FIG. 9a;

FIG. 9c is a side view schematically showing an inner die part of the extruder die shown in FIG. 9a;

FIG. 9d shows in schematic cross-section the inner die part of the extruder die shown in FIG. 9c;

FIG. 9e shows in schematic plan view the lower face of the extruder die shown in FIG. 9a;

FIG. 10 shows an exploded schematic perspective view of a lower portion of the extruder die shown in FIG. 9a;

FIG. 11 shows in schematic cross-section an extrusion assembly containing the extruder die shown in FIG. 9a;

FIG. 12 shows a schematic perspective view of an extruded cane preform manufactured using the extrusion assembly shown in FIG. 11;

FIG. 13a shows a schematic perspective view of the extruded cane preform of FIG. 12 within a tubular outer cladding so forming an optical fibre preform;

FIG. 13b shows a schematic perspective view of the extruded cane preform of FIG. 12 within a capillary stacked outer cladding;

FIG. 14 shows a schematic perspective view of an upper part of a drawing tower for drawing optical fibres;

FIG. 15a is a photograph of a first example of a cane preform manufactured according to a first embodiment of the invention;

FIG. 15b is a photograph of a first example of a caned preform manufactured according to a first embodiment of the invention;

FIG. 15c is a scanning electron microscope image of a first example of a drawn optical fibre according to a first embodiment of the invention;

FIG. 15d is an optical microscope image of an alternative example of a drawn optical fibre according to a variant of the first embodiment of the invention;

FIG. 16a is a contour plot which schematically shows the modelled mode shape of the optical fibre at 633 nm shown in FIG. 15c;

FIG. 16b is a plot which schematically shows the measured mode profile of the optical fibre shown in FIG. 15c at 633 nm;

FIG. 17a shows in schematic cross-section an extruder die according to a second embodiment of the invention;

FIG. 17b shows in schematic cross-section an outer die part of the extruder die shown in FIG. 17a;

FIG. 17c is a side view schematically showing an inner die part of the extruder die shown in FIG. 17a;

FIG. 17d shows in schematic cross-section the inner die part of the extruder die shown in FIG. 17c;

FIG. 17e shows in schematic plan view the lower face of the extruder die shown in FIG. 17a;

FIG. 18a shows in schematic cross-section an extruder die according to a third embodiment of the invention;

FIG. 18b shows in schematic cross-section an outer die part of the extruder die shown in FIG. 18a;

FIG. 18c is a side view schematically showing an inner die part of the extruder die shown in FIG. 18a;

FIG. 18d shows in schematic cross-section the inner die part of the extruder die shown in FIG. 18c;

FIG. 18e is a schematic perspective view of a spider disc and mandrel assembly of the extruder die shown in FIG. 18a;

FIG. 18f shows in schematic plan view the lower face of the extruder die shown in FIG. 17a;

FIG. 18g shows a schematic perspective view of an extruded cane preform manufactured using the extruder die shown in FIG. 18a;

FIG. 19a is a side view schematically showing an inner die part of an extruder die according to a fourth embodiment of the invention;

FIG. 19b shows in schematic plan view the lower face of an extruder die according to a fifth embodiment of the invention;

FIG. 19c shows a schematic perspective view of an extruded cane preform manufactured using the extruder die shown in FIG. 19b;

FIG. 19d is a side view schematically showing an inner die part of an extruder die according to a sixth embodiment of the invention;

FIG. 20 shows in schematic plan view the lower face of several extruder dies according to further embodiments of the invention;

FIG. 21 schematically shows a 1300 nm fibre amplifier based on a Pr:doped gallium lanthanum sulphide microstructured fibre;

FIG. 22 is a graph showing the Raman amplification process of a Raman amplifier incorporating microstructured optical fibre;

FIG. 23 illustrates schematically a Brillouin laser based on a length of microstructured optical fibre;

FIG. 24 schematically shows an Er:doped gallium lanthanum sulphide microstructured fibre laser;

FIG. 25 schematically shows a high power Nd:doped microstructured fibre laser;

FIG. 26 schematically shows a spectral broadening device based on a compound glass microstructured fibre;

FIG. 27 schematically shows a cross-section through a microstructured fibre for gas sensing;

FIG. 28 schematically shows a gas sensor using the fibre of FIG. 27;

FIG. 29 is an optical switch based on a gallium lanthanum sulphide microstructured fibre grating;

FIG. 30 is a further optical switch based on a null coupler made of gallium lanthanum sulphide microstructured fibre;

FIG. 31 is a schematic longitudinal axial section through a forward-interaction second harmonic generator (SHG) device; and

FIG. 32 is a schematic drawing of a backward-interaction three-wave mixing (TWM) device embodying the invention.

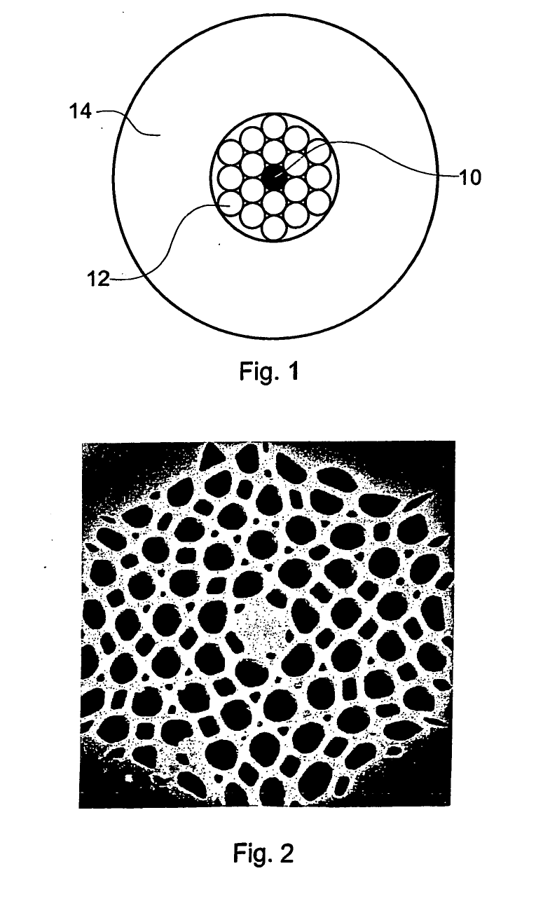

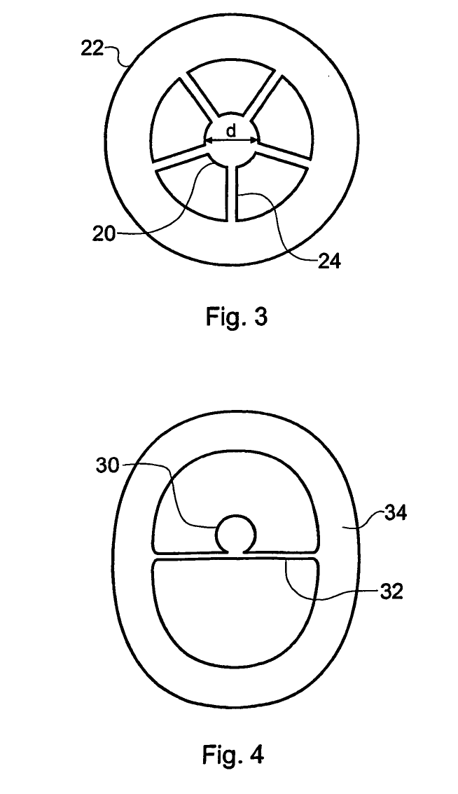

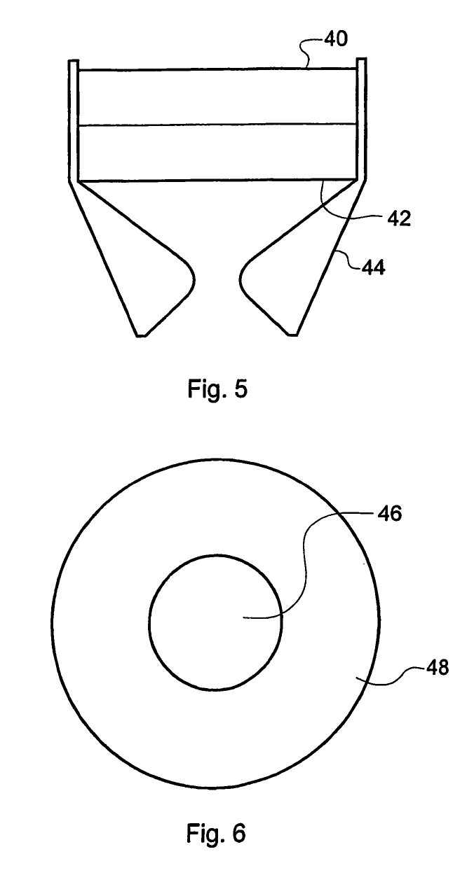

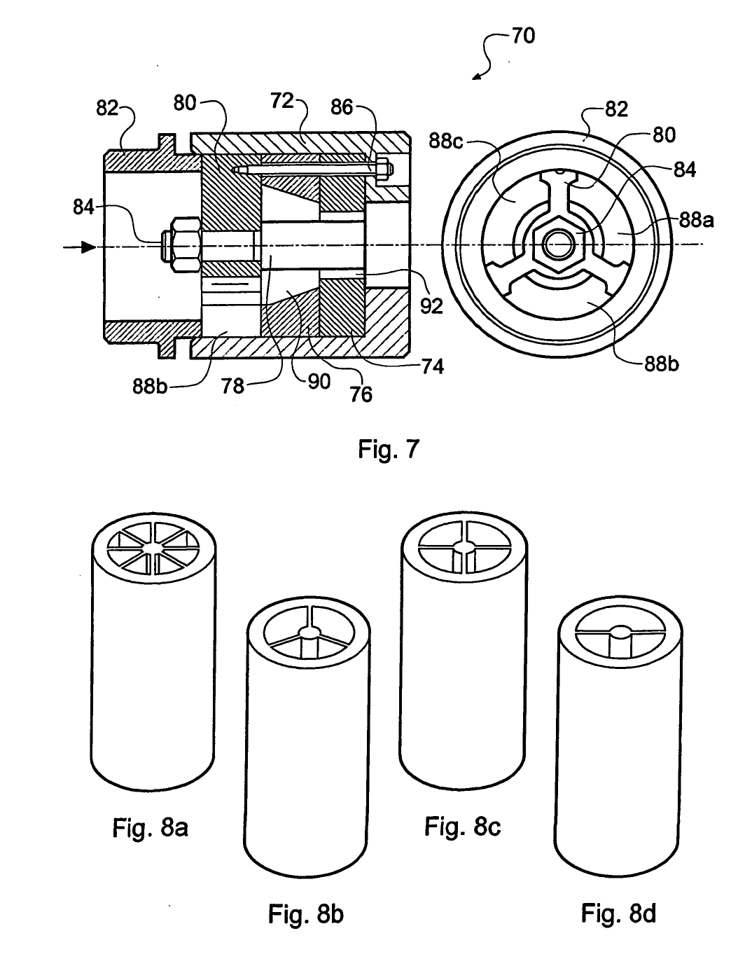

### DETAILED DESCRIPTION

### First Embodiment

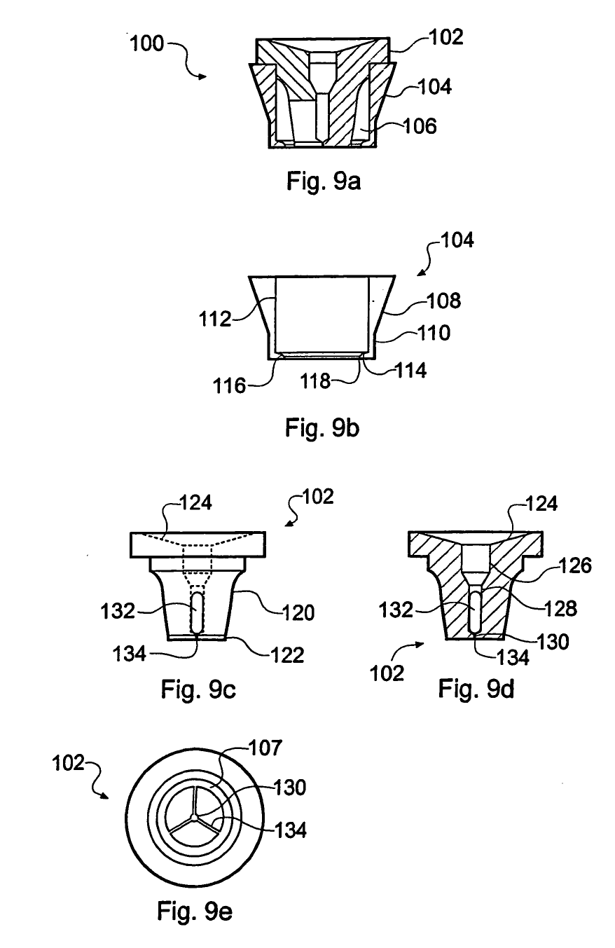

FIG. 9a schematically shows in vertical section an extruder die 100 for use in manufacturing a cane preform for drawing into an optical fibre according to a first embodiment of the invention. In this example, the extruder die 100 is manufactured from stainless steel grade 303 which is polished to reduce friction. In certain circumstances other materials may be more appropriate, for example where a higher extrusion temperatures is preferred or different bulk mechanical properties of the die are required. Additionally, surface coatings may be applied to the die to assist the extruding process. The die 100 comprises an inner die part 102 and an outer die part 104 which together define a welding chamber 106 which opens to the lower face of the extruder die 100.

FIG. 9b schematically shows in vertical section the outer die part 104. In this example, the outer die part 104 is cylindrically symmetric. The external profile consists of a tapered cone 108 ending in a parallel diameter 110. The inner profile consists of a parallel bore 112 of suitable diameter to mate with the inner die part 102 and which terminates in a tapering step 114 and a radius edge 116 to create a reduced bore profile 118.

FIG. 9c schematically shows a side view of the inner die part 102. In this example, the inner die part 102 has three-fold rotational symmetry about a central vertical axis. The external vertical face 120 of the inner die part is circular and stepped with a tapered region and ending in a parallel spigot 122 as shown in the figure. The upper face of the inner die part 102 has a concave taper 124.

FIG. 9d schematically shows in vertical section the inner die part 102. On the centre axis of the inner die part 102 there is a first axial channel 126 in fluid communication via a taper with a narrower second axial channel 128 which is in turn is in fluid communication with a still narrower third axial channel 130. The first axial channel 126 and third axial channel 130 are respectively open to the upper and lower faces of the inner die part 102. The first and second 126, 128 axial channels combine to form a central feed channel and the third axial channel 130 forms a cane preform core forming conduit The second axial channel 128 is in fluid communication with a group of three equi-angularly spaced radial flow diversion channels 132 which extend to the external face 120 of the inner die part 102. The third axial channel 130 is in fluid communication with a further group of three equi-angularly spaced radial flow diversion channels 134 defined by pairs of mutually facing internal walls and which also extend to the external face 120 of the inner die part 102. The radial channels 132 and the radial channels 134 are aligned and in vertical fluid communication with the radial channels 134 open to the lower face of the inner die part 102.

FIG. 9e schematically shows a view of the lower face of the extruder die 100 and demonstrates the openings of the third axial channel 130, the radial channels 134 and a cane preform wall forming opening 107 associated with the gap formed between the reduced bore profile 118 of the outer die part 104 and the outer profile of the parallel spigot 122 of the inner die part. The openings in the lower face of the extruder die combine to form a nozzle for extrusion.

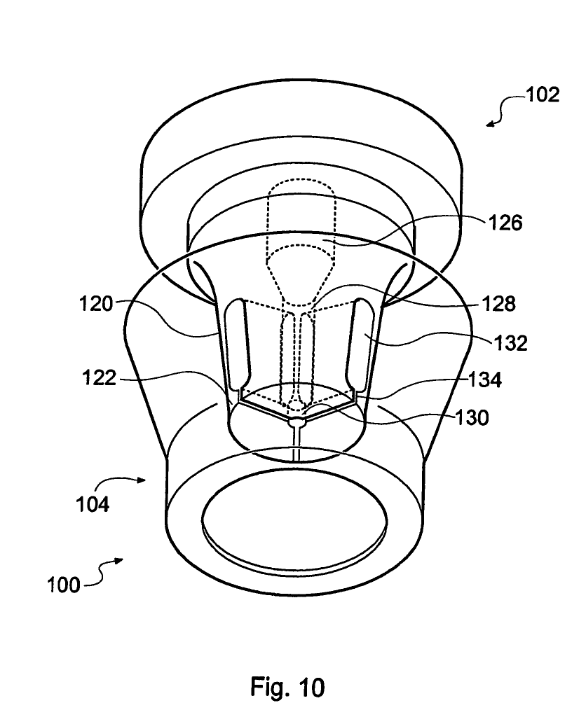

FIG. 10 is an exploded schematic perspective view of a lower portion of the die 100 and which further details the layout of the axial 126, 128, 130 and radial 132, 134 channels within the inner die part 102.

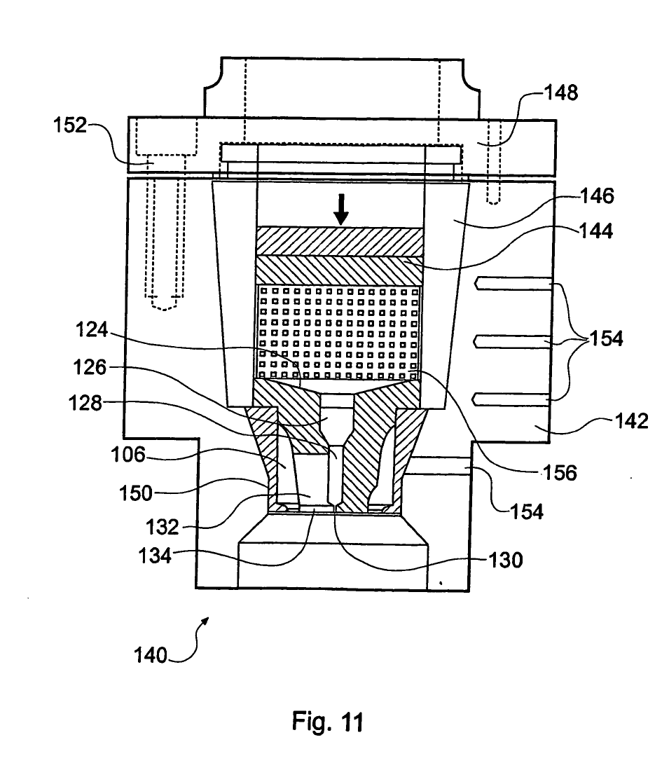

FIG. 11 shows the extruder die 100 in use within an extruder die assembly 140. The extruder die assembly 140 comprises a main body 142, a piston 144, a sleeve 146 and a cap 148. Towards the bottom of the main body 142 a recess is shaped to receive and locate the extruder die 100. The lower face of the extruder die assembly 140 is open as indicated in the figure. The extruder die assembly 140 is held together by fixings 152. The temperature distribution within the extruder die assembly 152 is measured by a number of thermocouples (not shown) which are mounted in a plurality of thermocouple recesses 154. In operation, the extruder die assembly 140 is loaded with a billet of glass 156 located between the upper face of the extruder die 100 and the lower face of the piston 144 and within a cavity formed by the sleeve 146. The sleeve 146 is removable such that it can be easily cleaned or replaced after each extrusion process.

The process of extrusion begins by first heating the extruder die assembly 140 with a heater (not shown) such that the viscosity of the glass 156 is suitable for the chosen extruder die profile. Trial and error is used to optimise the viscosity for each glass or polymer. When the suitable temperature is obtained, the piston 144 is driven towards the extruder die 100 by an external vertically applied force schematically indicated by the arrow. The applied force is such that the glass 156 is extruded at a suitable pressure and velocity and may, for example, be generated by a hydraulic ram applied to the upper surface of the piston 144. The applied force is optimised by trial and error for each glass or polymer. Under the application of the external force the glass 156 is forced into the extruder die 100. The glass 156 fills the volume defined by the concave taper 124 and is further forced into the first axial channel 126 and subsequently along a feed direction into the second axial channel 128. A component of the glass 156 from the second axial channel 128 is forced onward into the third axial channel 130, whereas a second component is diverted radially by the radial channels 132 to fill the welding chamber 106. The separate glass streams entering the welding chamber 106 from the three of the radial channels 132 expand circumferentially within the welding chamber 106 and re-weld into a single continuous tubular form. A combination of glass 156 from the welding chamber 106, the radial channels 132 and the third axial channel 130 is further urged to fill the radial channels 134.

At this stage of the extrusion process, the air spaces within the extruder die 100 are filled with glass and under continued application of the pressure inducing force, glass begins to be extruded from the nozzle of the extruder die 100. The glass is extruded in a pattern which is determined by the openings in the lower face of the extruder die 100 indicated in FIG. 9e.

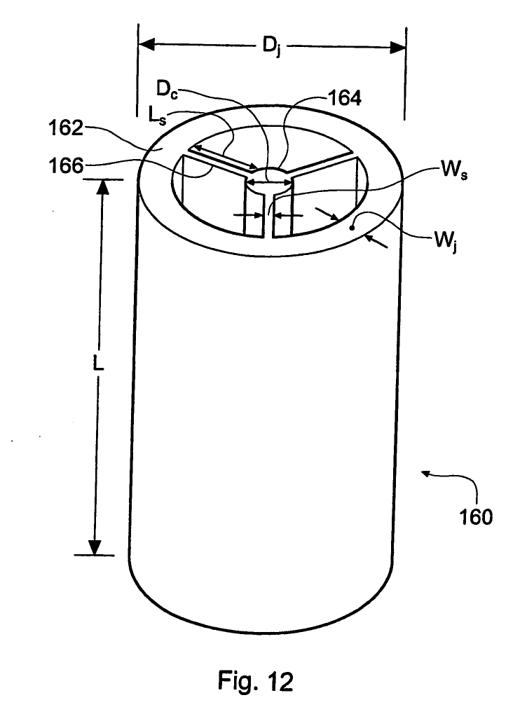

FIG. 12 is a schematic perspective view of a glass cane preform 160 obtained from the extruder die assembly 140. The preform 160 comprises an outer wall 162 of tubular form and with a wall thickness Wⱼ and outer diameter Dⱼ, a central core 164 of circular cross-section and diameter D_{c} and three linear radial struts 166 of width Wₛ and length Lₛ. The cane preform 160 has an overall length of L. The outer wall 162 is created by glass extruded through the opening 107 in the lower face of the extruder die 100 defined by the gap between the inner die part 102 and the outer die part 104. Its dimensions are accordingly determined by those of the outer diameter of the parallel spigot 122 and the inner diameter of the reduced bore profile 118. The central core 164 is created by the opening of the third axial channel 130 in the lower face of the extruder die 100 and its diameter accordingly determined by that of the channel 130. The struts 166 are created by the opening of the of radial channels 134 in the lower face of the extruder die 100 and their dimensions accordingly determined by the horizontal cross-section of these channels 134.

The cane preform 160 is especially suited for fabricating an optical fibre in which the central core 164 becomes a light guiding core supported within the drawn wall 162 by the drawn struts 166. Unlike previous die designs, the central core 164 formed by the extruder die 100 comprises glass which has not undergone splitting into separate streams and re-welding within the die. This is important for maintaining high optical integrity of the glass in the core region of the drawn fibre. As noted by Roeder & Egel-Hess, the re-welded glass of prior art extruder dies does not provide extrusions suitable for optical applications. The present die design further allows the cross-section of the cane preform 160 to display a wide range of wall thicknesses. This is achieved by lowering surface friction in some areas by reducing the path length of the flowing glass within various channels, and injecting greater volumes of glass into regions requiring greater wall thickness. For example, wall 162 width Wⱼ to strut 166 width Wₛ ratios of 5.4:1, 12:1 and 15:1 have been achieved. The strut 166 length Lₛ can also be several times longer than the strut 166 width Wₛ. Strut length Wⱼ to strut width Wₛ ratios of 5:1 and 12.5:1 have been prepared in specific examples.

The first stage of drawing the cane preform 160 into an optical fibre is caning. The extruded cane preform outer diameter Dⱼ might typically be around 10-30 mm. The cane preform 160 is caned down to produce a cane which has a diameter around ten times smaller than the cane preform 160, the caning can, for example, be done in a drawing tower. In the process of pulling the cane preform into the cane (or even directly into a fibre), it can be desirable to seal the end of the cane preform or alternatively to actively pressurise the structure relative to the external environment in order to help to prevent collapsing during the draw due to surface tension effects. The cane is then further drawn to provide a suitably sized guiding core. To provide sufficient structural rigidity, a supporting cladding region is generally applied to the cane to provide a fibre preform for drawing.

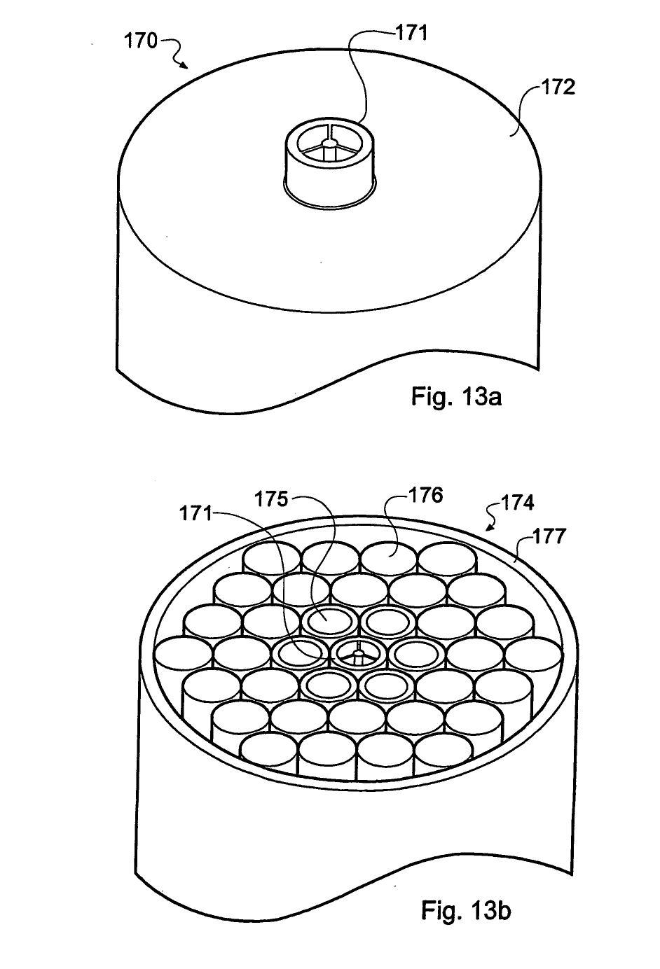

FIG. 13a is a schematic perspective view a fibre preform 170 which is to be drawn to form an optical fibre. The fibre preform 170 comprises a cane 171 made from the preform 160 provided by the extruder die assembly 140 and a supporting tube 172. The cane 171 is placed within the supporting tube 172 to form the fibre preform 170. The inner diameter of the supporting tube 172 closely matches the outer diameter of the cane 171. The outer diameter of the supporting tube 172 is chosen to suit the desired outer geometry of the fibre to be drawn. The supporting tube 172 may be manufactured by any suitable means, including extrusion. The supporting tube 172 may preferentially be made of the same material as the cane 171 to ensure mechanical and thermal compatibility. However, if a specialist glass is used for the original preform 160, it may be more appropriate for the supporting tube 172 to be of a different suitable material.

During drawing, it can be advantageous to apply a vacuum to the space between the outside of the cane and the inside of the supporting tube. This inhibits contraction of the cane and generates a force that acts to close the space. As a result, during drawing of fibre, the outer wall of the cane bonds with the inner wall of the supporting tube to form a single structure.

FIG. 13b is a schematic perspective view of an alternative fibre preform structure 174 which could be drawn into an optical fibre. The cane 171 is incorporated within a structured surround comprising a hexagonally packed array of tubes and/or rods 175, 176. In this example, the cane 171 is surrounded by a first ring of glass tubes 175 and two further rings of solid glass rods 176. In another example, the solid rods may be replaced with tubes. The assembly is held together by a glass outer jacket 177. As with the support cladding 172 shown in FIG. 13a, some or all of the structured surround components 175, 176, 177 may be made of the same glass 156 as the cane 171. The tubes 175 may be particularly useful for incorporating electrodes for thermally poling the drawn fibre. The electrodes can be created by inserting metal wires (e.g. gold or tungsten) into the holes in one or more tubes 175 before caning or drawing. Electrodes may also be located interstitially with respect to the lattice formed by the tubes 175 and/or rods 176 which form the support cladding region. Instead of using metal wires, the electrodes could also be drawn from graphite, graphite alloy or graphite doped rods. Other conductive materials or dopants may also be used. Alternatively, the electrodes may be inserted into the holes after fibre drawing.

A still further alternative would be to extrude a preform with sufficiently large outer diameter Dⱼ that no further cladding is required. Such a preform has even fewer glass-glass or air-glass interfaces which are often a source of contamination in optical fibres. A preform with an outer diameter which is large enough to remove the need for further cladding may require multiple caning and or drawing stages to provide suitable drawn fibre dimension or may be drawn directly into a fibre.

FIG. 14 shows a furnace used to draw a fibre preform into an optical fibre. In the process of pulling the fibre preform it is typically sealed at the top (where the bottom is defined as the portion that will be fed through the furnace first). This is in order that the holes in the cross-sectional structure of the cane do not collapse during fibre drawing. This could also potentially be achieved by setting an over-pressure for the holes that define the cross-sectional structure (relative to the outside pressure). Another approach, that could be used either on its own or in conjunction with the above mentioned methods would be to evacuate the space between the cane and the supporting jacket that surrounds the cane in the fibre preform during the fibre pulling process. This provides a pressure differential during the draw process, which should keep the holes in the caned preform open whilst closing up any undesirable gaps between the support jacket and the microstructured cane. These techniques can also be applied to the voids within a structured support jacket of the fibre preform (such as within tubes, or located interstitially between rods and/or tubes forming the structured support jacket) which can be encouraged to either close up or remain open as desired during drawing. The furnace incorporates an inductively heated (RF) hot zone defined by water-cooled helically wound RF coils 180. In use, the water cooled RF coils generate an RF field that heats a graphite susceptor (not visible). In the illustrated furnace, the RF coils define a 50 mm long hot zone around and along the fibre preform.

A combination of water and gas cooling is provided above and below the hot zone. The cooling keeps the material outside the hot zone cooled to below its crystallisation temperature. Elements of the cooling system are apparent from the figure, namely an upper gas halo 182, a lower gas halo 184, a cold finger 186, and a water jacket 188 made of silica. The upper gas halo and silica water jacket cool the fibre preform prior to entry into the hot zone. The cold finger, and lower gas halo provide rapid cooling after the fibre emerges from the hot zone. A thermocouple 190 for monitoring furnace temperature is also indicated. The thermocouple forms part of a control system for regulating the furnace temperature.

Other furnace types are also suitable, for example based on resistive heating such as a graphite resistance furnace.

A range of different coating materials can be used for coating the outside of a fibre preform prior to or during drawing. Examples of coating materials are standard acrylates, resin, Teflon (trade mark), silicone rubber, epoxy or graphite. In particular, graphite coating can be used to good effect since it promotes stripping of cladding modes and also provides enhanced mechanical strength.

Depending on the desired final geometry and the geometry of the cane, multiple stages of drawing may be necessary.

### First Embodiment: Example

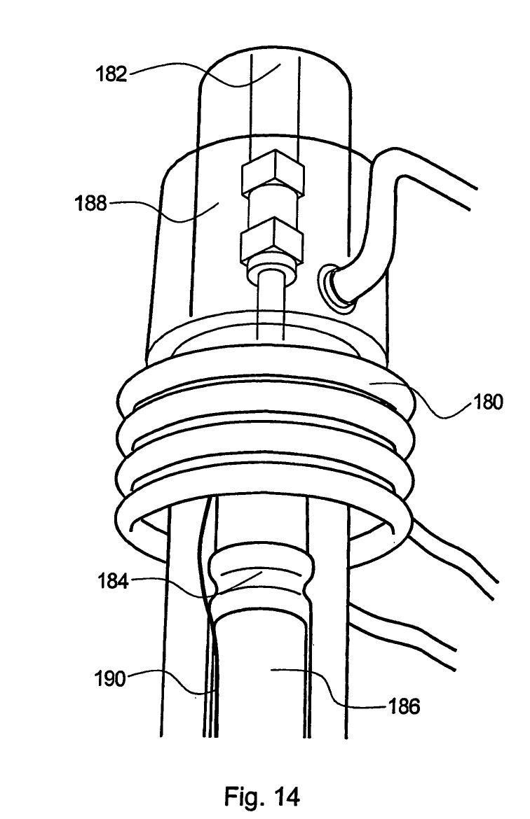

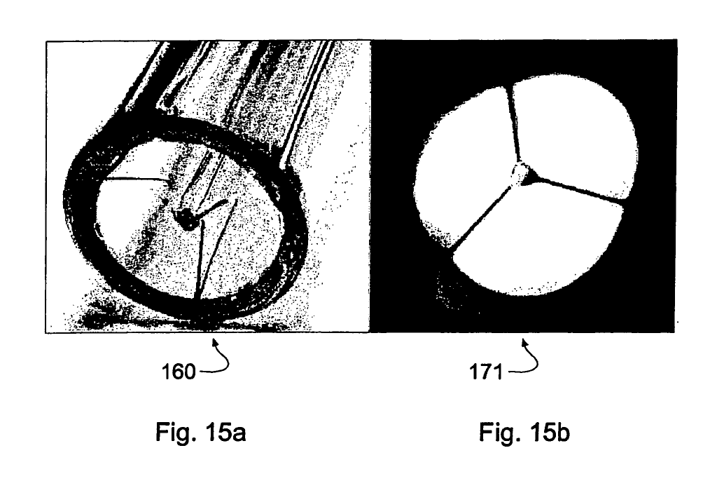

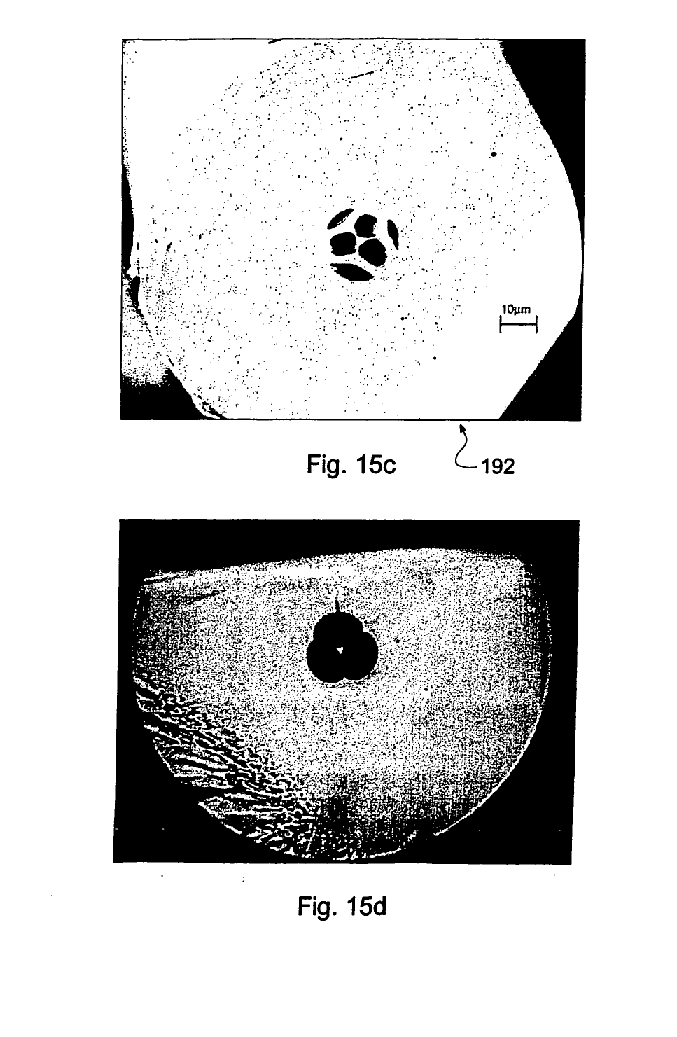

FIG. 15a is a photograph showing an extruded cane preform 160 which has been fabricated using an extruder die 100 according to the first embodiment of the invention described above.

The cane preform 160 is made from SF57 glass, a commercially available Schott glass. The high lead concentration of this glass leads to a high refractive index of 1.83 at 633 nm and 1.80 at 1.53 μm with losses in the bulk glass of 0.7 dB/m at 633 nm and 0.3 dB/m at 1.53 μm. The non-linear refractive index (n₂) measured at 1.06 μm is 4.110⁻¹⁹ W²/m [4], more than an order of magnitude larger than that of pure silica glass fibres [5]. Since the effective non-linearity of a fibre is γ=n₂/A_{eff}, where A_{eff} is the effective mode area. The combination of this glass with the small effective areas (A_{eff}) possible in micro-structured fibres allows for dramatic improvements in the non-linearity that can be achieved.

SF57 glass has a low softening temperature (519° C.). The cane preform 160 was extruded from bulk SF57 glass. A cross-section through the extruded cane preform 160 has an outer diameter (OD) of 16.5 mm, strut thickness 0.375 mm, strut length 5.65 mm, preform length about 10 cm and core diameter 1.2 mm. As described above, and as seen in FIG. 15a, the cane preform is comprised of a central core 162 supported by three long struts 166. This transverse structure extends along the entire cane preform length L.

FIG. 15b is a photograph showing a cane 171 created by caning the extruded cane preform 160 shown in FIG. 15a down to an OD of 1.6 mm with the other dimensions reducing roughly to scale. It is evident that the cross-sectional shape of the cane preform 160 is well maintained in the cane 171. The cane 171 is inserted within an extruded jacketing tube 172, as schematically shown in FIG. 13a, and the resulting fibre preform is drawn down to 120 μm OD optical fibre.

FIG. 15c is a scanning electron microscope image of an optical fibre 192 drawn from the fibre preform 170 described above. In this process, extremely small features have been retained within the final fibre 192 without compromising practicality and handling.

Visual inspection of the drawn fibre 192 indicates that this cross-sectional profile remained essentially unchanged over more than 50 m of the fibre. The central core diameter in this example drawn fibre is 2 μm and the central core is suspended by three 2 μm long struts that are less than 400 nm thick. The supporting struts allow the solid central core to guide light by helping to isolate the central core from the outer solid regions of the fibre cross-section.

In FIG. 15c three elongate cross-section holes are evident outside the core and strut structure. These holes have formed because of partial collapse of the cane during drawing. This can be prevented by applying vacuum suction between the cane and supporting tube during drawing, as mentioned above in relation to FIG. 13a

FIG. 15d shows a holey fibre drawn using a vacuum in this way. As is evident there are no outer elongate holes, the gap between the outside of the cane and the supporting tube having been closed during drawing.

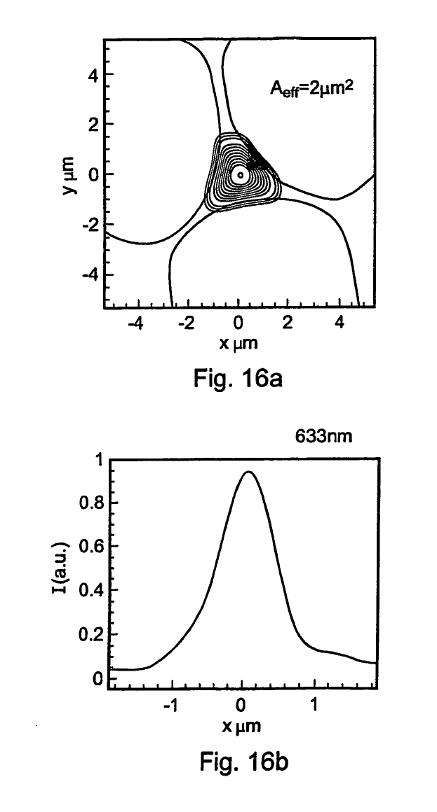

FIG. 16a is a contour plot showing the predicted mode profile at 633 nm in the xy plane (defined to be perpendicular to the longitudinal axis of the fibre) of the fibre 192 as a function of position x,y from the central axis of the fibre, individual contours are separated by 1 dB. Measurements taken from the scanning electron microscope image shown in FIG. 15c are used to define the transverse structure and an efficient modal model [6] used to predict the properties of the fibre at 633 μm. In FIG. 16a the predicted mode profile shown is superimposed on the geometry of the core region. The effective mode area is A_{eff}=2 μm², comparable to the smallest areas achieved in silica microstructured fibres. Hence these SF57 fibres offer values of the effective non-linearity γ that are three orders of magnitude higher than conventional silica optical fibres.

FIG. 16b is a graph showing an experimentally determined mode profile for the fibre 192 at 633 nm and shows the intensity I as a function of radial distance x from the central axis of the fibre 192. Robust single-mode guidance was observed in the fibre at both 633 nm and 1500 nm.

Although single-material fibres support only leaky modes, it is possible to design low-loss fibres of the type shown in FIG. 15c [6]. This can be done by ensuring that the supporting struts are long and fine enough that they act purely as structural members that isolate the core from the external environment. In the final fibre, the struts may have radial lengths of at least 2 micrometers, up to 20 micrometers or longer. The strut widths will generally be smaller than the radial length by a factor of at least 2 and as much as 10 or 20 or more.

The fibres can be effectively single-mode over a broad range of wavelengths since the confinement losses associated with any higher order modes are significantly higher than that of the fundamental mode. Note that confinement losses typically increase with wavelength.

Another design option is to make the struts with variable cross-sectional thickness. For example, the struts may be thicker at either end (at the core end and outer wall end) and thinner in the middle, incorporating a smooth inward and outward taper. A single taper from thin at the core to thick at the outer wall, or vice versa could also be implemented. This could, for example, alter the structural properties of the fibre without significantly effecting the optical properties of the fibre.

We observe approximately 3 dB/m loss at 633 nm and 10 dB/m at 1550 nm, significantly larger than the material loss at each wavelength. We anticipate that the confinement loss would decrease significantly when still longer struts are used. The strut length in the fibre in FIG. 15c was not limited by the extrusion process, as FIGS. 15a and 15b attest, and so we anticipate further improvements.

### Second Embodiment

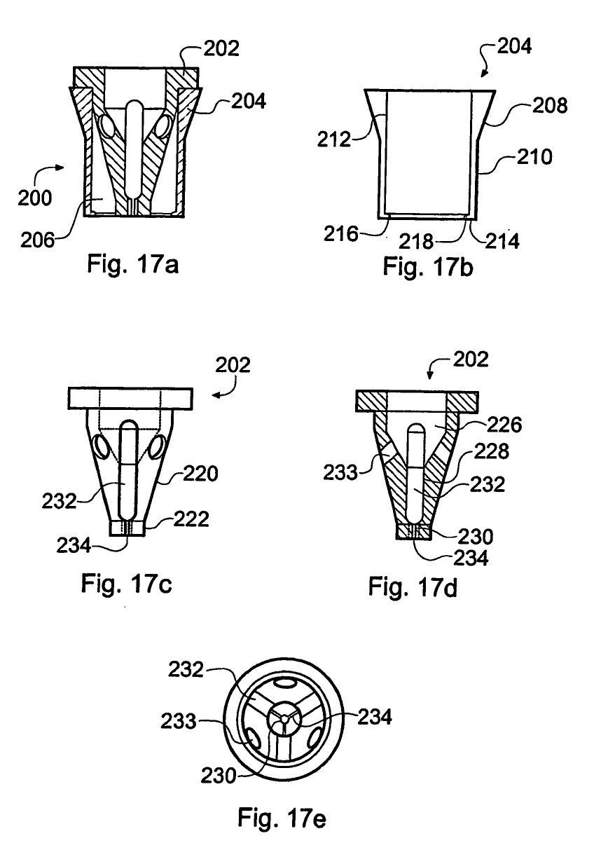

FIG. 17a schematically shows in vertical section an extruder die 200 for use in manufacturing an optical fibre preform according to a second embodiment of the invention. This particular embodiment is designed to produce a cane preform with greater cross-sectional outer wall thicknesses. In this example, the extruder die 200 is again manufactured from stainless steel grade 303, and is polished to reduce friction. The die 200 comprises an inner die part 202 and an outer die part 204 which together define a welding chamber 206 which is in fluid communication with an opening to the lower face of the extruder die 200.

FIG. 17b schematically shows in vertical section the outer die part 204. In this example, the outer die part 204 is cylindrically symmetric. The external profile consists of a tapered cone 208 ending in a parallel diameter 210. The inner profile consists of a parallel bore 212 of suitable diameter to mate with the inner die part 202 and which terminates in a tapering step 214 and a radius edge 216 to create a reduced bore profile 218.

FIG. 17c schematically shows a side view of the inner die part 202. In this example, the inner die part has three-fold rotational symmetry. The vertical external face 220 of the inner die part is circular and stepped with a tapered region and ending in a parallel spigot 222 as shown in the figure.

FIG. 17d schematically shows in vertical section the inner die part 202. On the centre axis of the inner die part 202 there is a first axial channel 226 in fluid communication via a taper with a narrower second axial channel 228 which is in turn is in fluid communication with a still narrower third axial channel 230. The first axial channel 226 and third axial channel 230 are respectively open to the upper and lower faces of the inner die part 202. The first and second axial channels 226, 228 combine to form a central feed channel and the third axial channel 230 forms a cane preform core forming conduit. The first and second axial channels 226, 228 are in fluid communication with a group of three equi-angularly spaced radial flow diversion channels 232 which extend to the external face 220 of the inner die part 202. The third axial channel 230 is in fluid communication with a further group of three equi-angularly spaced radial flow diversion channels 234 defined by pairs of mutually facing internal walls and which also extend to the external face 220 of the inner die part 202. The radial channels 232 and the radial channels 234 are aligned and in vertical fluid communication with the group of radial channels 234 open to the lower face of the inner die part 202. The first axial channel 226 is also in fluid communication with a still further group of three equi-angularly spaced radial channels 233 which extend obliquely to the external face 220 of the inner die part 202. The channels 233 are angularly inter-spaced between the radial channels 232 and angled downwards along a radially outward direction as indicated in FIG. 17d.

FIG. 17e schematically shows a view of the lower face of the inner die part 202 and demonstrates the openings of the third axial channel 230 and the radial channels 234. The projected opening of the radial channels 232,233 are also shown.

The operation of the die 200 in a glass extrusion process will be similar to and understood from the description given above with reference to the first embodiment. However, in the die 200, the combined increased flow capacity of the radial channels 232, 233 (both because the radial channels 232 are of relatively longer extent along the feed direction than in the first embodiment and the group of radial channels 233 are additional) allow the welding chamber 206 to be relatively larger than the welding chamber 106 of the first embodiment. Since relatively more glass is diverted to the relatively large welding chamber 206, thicker walls can be efficiently extruded from the die 200.

### Third Embodiment

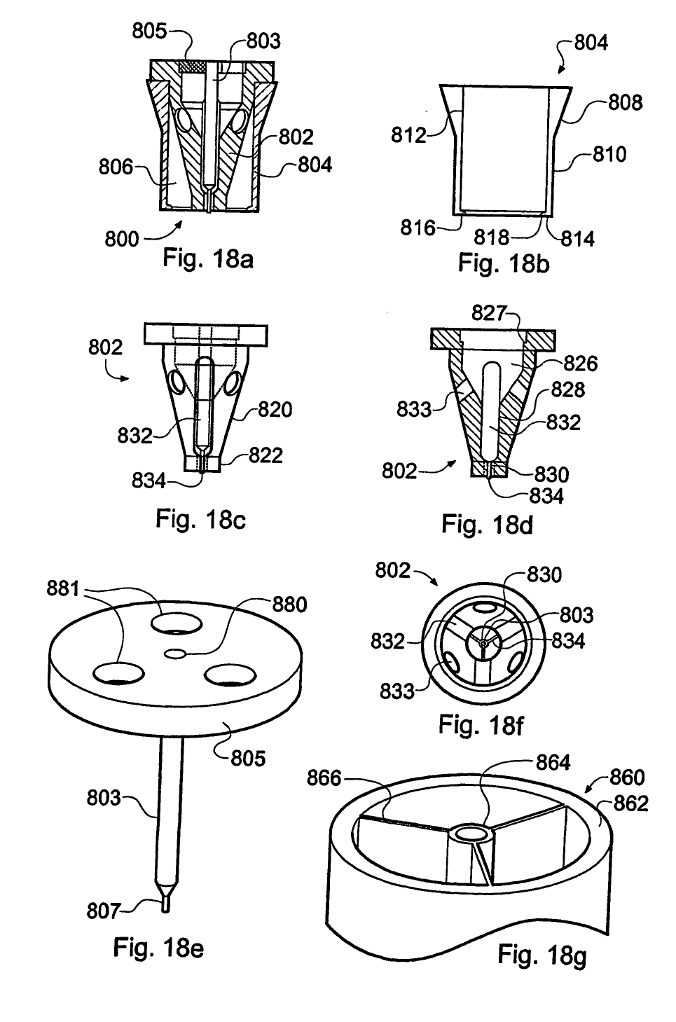

FIG. 18a schematically shows in vertical section an extruder die 800 for use in manufacturing an optical fibre preform according to a third embodiment of the invention. This particular embodiment is designed to produce a cane preform in which the central core is hollow. In this example, the extruder die 800 is again manufactured from stainless steel grade 303, and is polished to reduce friction. The die 800 comprises an inner die part 802 and an outer die part 804 which together define a welding chamber 806 which is in fluid communication with an opening to the lower face of the extruder die. The extruder die 800 further comprises a spider disc 805 and a mandrel 803.

FIG. 18b schematically shows in vertical section the outer die part 804. In this example, the outer die part 804 is cylindrically symmetric. The external profile consists of a tapered cone 808 ending in a parallel diameter 810. The inner profile consists of a parallel bore 812 of suitable diameter to mate with the inner die part 802 (as shown in FIG. 18a) and which terminates in a tapering step 814 and a radius edge 816 to create a reduced bore profile 818.

FIG. 18c schematically shows a side view of the inner die part 802. In this example, the inner die part has three-fold rotational symmetry. The vertical external face 820 of the inner die part is circular and stepped with a tapered region and ending in a parallel spigot 822 as shown in the figure.

FIG. 18d schematically shows in vertical section the inner die part 802. On the centre axis of the inner die part 802 there is a central feed channel made up of a first axial channel 826 in fluid communication via a taper with a narrower second axial channel 828. The second axial channel 828 is in turn in fluid communication with a still narrower third axial channel 830 that forms the core forming conduit. The outer diameter of the first axial channel 830 changes from a first value to a second value to define a stepped recess 827 as indicated in the figure. The first axial channel 826 and third axial channel 830 are respectively open to the upper and lower faces of the inner die part 802. The first and second axial channels 826, 828 are in fluid communication with a three equi-angularly spaced radial flow diversion channels 832 which extend to the external face 820 of the inner die part 802. The third axial channel 830 is in fluid communication with a further three equi-angularly spaced radial flow diversion channels 834 defined by pairs of mutually facing internal walls and which also extend to the external face 820 of the inner die part 802. The radial channels 832 and the radial channels 834 are aligned and in vertical fluid communication. The radial channels 834 are further open to the lower face of the inner die part 802. The first axial channel 826 is also in fluid communication with a still further group of three equi-angularly spaced radial channels 833 which extend obliquely to the external face 820 of the inner die part 802. The radial channels 833 are angularly inter-spaced between the radial channels 832 and angled downwards along a radially outward direction as indicated by their projected appearance marked on the vertical section drawing shown in FIG. 18d.

FIG. 18e is a schematic perspective view showing the assembled spider disc 805 and mandrel 803. The spider disc 805 has the form of a flat circular disc with a plurality of holes 880, 881. A first central hole 880 is tapped and able to receive and hold the mandrel 803 centrally in, and extending perpendicularly to, the spider disc 805. In this example, the mandrel 803 is a circularly symmetric with a threaded upper part (not shown) for affixing the mandrel into the tapped hole 880. The outer profile of the mandrel has the form of a cylindrical section of a first diameter and which tapers down to a cylindrical section of a second smaller diameter at its distal end to form a downwardly depending peg 807 which sleeves into the core forming conduit 830. The remaining holes 881, of which in this example there are three, are radially displaced from the central axis of the spider disc and allow fluid communication between the upper and lower circular faces of the spider disc. The outer diameter of the spider disc matches the outer diameter of the upper part of the first axial channel 826 such that in operation the spider disc 805 is restrained and seated within the recess 827. With the spider disc 805 seated within the inner die part 802, the mandrel 803 extends centrally along the first, second and third axial channels. The outer dimensions of the mandrel 803 are such that it is able to pass freely through the axial channels whilst a fluid communication path between the axial channels is maintained. The length of the mandrel 803 is such that it extends throughout the inner die part 802 and terminates with the end of the peg 807 at or around its lower face.

FIG. 18f schematically shows a view of the lower face of the inner die part 802 and demonstrates the openings of the third axial channel 830 and the radial channels 834. The projected openings of the radial channels 832 and 833 and the end of the mandrel 803 are also shown.

In operation, the die 800 is mounted in a die extruder assembly which is similar to and will be understood from that shown in FIG. 11 in connection with the first embodiment. However, during extrusion the glass flow pattern within the body of the die is slightly different to that of the first embodiment. Under application of the extruding force, the glass is forced through the holes 881 in the spider disc 805 and reforms within the first axial channel 826 in the space surrounding the mandrel 803. The glass flow from this channel to the radial channels 832 and 834 and to the welding chamber 806 is similar to and will be understood from the description given above in connection with the second embodiment. However, the component of glass which passes along the second and third axial channels is now only able to pass between the outer diameter of the mandrel 803 and its peg 807 and the inner diameter of second and third axial channels 828 and 830. Accordingly, the effective core forming conduit formed by the axial channels and the mandrel has the cross-sectional form of an annular ring.

FIG. 18g is a schematic perspective view of a portion of a glass cane preform 860 obtained from the extruder die 800. The preform 860 comprises an outer wall 862 of tubular cross-section and three linear radial struts 866. These are formed in a manner which is similar to and will be understood from the corresponding features shown in FIG. 12. However, the central core 864 is different to that shown in FIG. 12. The core 864 is created by the gap surrounding the mandrel 803 within the opening of the third axial channel 830 in the lower face of the extruder die 800 and as such has a tubular cross-section as indicated in the figure. A fibre drawn from such a cane preform may, for example, support a ring mode. The hollow core may also be filled, for example, a second glass rod could be inserted into the hollow core of the cane preform prior to caning or drawing to provide a drawn fibre with different core glasses. Furthermore, the mandrel need not have a circular cross-section. An oval cross section could be used to produce a cane preform with a hollow core having a circular outer profile but an oval inner profile. In constructing a fibre preform from such a cane preform, in addition to a supporting jacket such as indicated in FIGS. 13a and 13b, the central hollow core may be filled prior to drawing. For example, a central cylindrical glass rod and two diametrically opposite wires could be inserted to allow poling of a small central core within a drawn fibre.

It will also be understood that other dies may be designed using these principles for making preforms with multiple hollow cores, or a mixture of hollow cores and solid cores wherein the cores may be located axially or parallel thereto displaced from the principal die axis.

### Fourth Embodiment

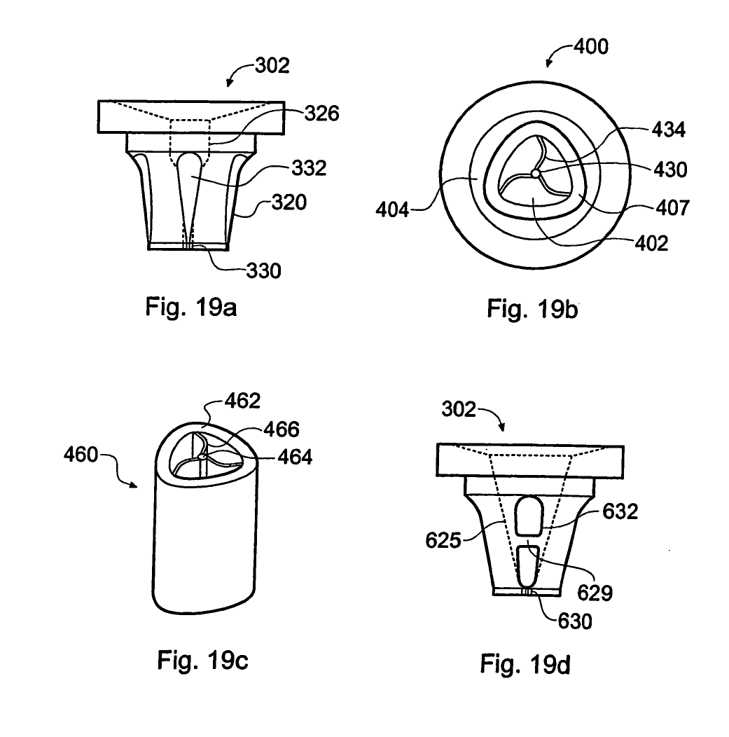

FIG. 19a schematically shows a side view of an inner die part 302 of a die according to a fourth embodiment of the invention. In operation, the inner die part 302 would combine with an outer die part which is not shown, but which would be similar to and understood from the description of the outer die part 104 of the first embodiment. In this example, the inner die part has four-fold rotational symmetry. The vertical external face 320 of the inner die part is circular and stepped with a tapered region and ending in a parallel spigot 322 as shown in the figure. On the centre axis of the inner die part 302 there is a first axial channel 326 in fluid communication via a taper with a narrower second axial channel (not shown) which is in turn is in fluid communication with a still narrower third axial channel 330. The first axial channel 326 and third axial channel 330 are respectively open to the upper and lower faces of the inner die part 302. The first 326 and second axial channels combine to form a central feed channel and the third axial channel 130 forms a cane preform core forming conduit. The first 326, second and third 330 axial channels are in fluid communication with a group of four equi-angularly spaced radial channels 332 which extend to the external face 320 of the inner die part 302. The cross-section of the radial channels 332 in a plane perpendicular to the diverted flow direction is inverse teardrop shaped with the bottom end open to the lower face of the inner die part 302, as shown in FIG. 19a. As glass is forced through the inner die part 302 during extrusion, the upper, wider parts of the radial channels 332 allow sufficient glass flow to fill a welding chamber formed by the inner die part 302 and the outer die part (not shown) to provide a thick outer wall for a cane preform, while the thinner openings of the radial channels 332 in the lower face of the inner die part 302 directly provide an extrusion path for forming a plurality of struts for supporting a central core in the cane preform.

### Fifth Embodiment

FIG. 19b schematically shows a plan view of a lower face (i.e. that which defines the extrusion cross-section) of an extruder die 400 according to a fifth embodiment of the invention.

The die 400 comprises an inner die part 402 and an outer die part 404 which combine to form a welding chamber in a manner which is similar to and will be understood from the description given above for the first embodiment. The outer profile of the inner opening on the lower face the outer die part 404 and the outer profile on the lower face of the inner die part 402 are of a rounded-triangular form with their vertices co-aligned as indicated in the figure. A central axial opening 430 is in fluid communication with a wall forming opening 407 (formed by the gap between the outer profile of the inner die part 402 and the inner profile of the outer die part 404 at the lower face of the die) via a group of three radial channels 434 formed by pairs of mutually facing internal walls. The radial channels 434 each contain a bend and intersect the wall forming opening 407 at the vertices of the rounded-triangle which describes its shape. Other than the shape of the openings in the lower face, the extruder die 400 will be functionally similar to and understood from the description given above for the first embodiment. The radial channels 434 and the fluid communication path between the wall forming opening 407 and the welding chamber may maintain their curved structure within the body of the extruder die 400 or may adopt it only towards the lower face.

FIG. 19c schematically shows a perspective view of a glass cane preform 460 extruded from the extruder die 400 shown in FIG. 19b. The cane preform 460 comprises a tubular outer wall 462 of rounded-triangle cross-section, a cylindrical central core 464 and bent/curved radial struts 466. The difference in the cross-sectional geometry of the cane preform 460 shown in FIG. 19c compared to the cane preform 160 shown in FIG. 12 helps to provide a circular cross-section in the drawn fibre. As seen in FIGS. 15a, 15b and 15c, the caning and drawing of the cane preform 160 of the first embodiment maintains the cross-sectional geometry well. There is, however, a level of azimuthal distortion caused by non-uniform contraction of the outer wall 162 and central core 164 due to the surface tension of the struts 166 during caning and drawing. The cane 171 (see FIG. 15b) and the final fibre 192 (see FIG. 15c) have slightly triangular cross sections.

The triangular cross-sectional geometry and bent struts 466 of the cane preform 460 extruded from the extruder die 400 reduces the effect on a cane and final fibre of the distortive pulling by the struts during the caning and drawing in two ways. Firstly, since the struts 466 are over-long to be purely radial, when they contract in length during caning and drawing, rather than pulling on the outer wall 462 and central core 464, they simply become less curved. Secondly, any residual pulling by the struts 466 on the outer wall 462 during caning and drawing will act at the vertices of the rounded-triangle defining the cross-sectional shape of the tubular wall 462 and so pull the caned and drawn wall 462 into a more circular form. Whilst the extruder die 400 shown in FIG. 19b makes use of both of these effects, each could be used independently. Other extruder die opening profiles may be used to counteract other effects of the strut contraction during drawing. For example, the central core opening may also be triangular with the radial channel openings in the lower face of the extruder die meeting the triangular central core in the middle of each of its sides. This would help to provide a circular core in the drawn fibre if desired.

Whilst the above described measures to counteract the effects of strut contraction during caning and drawing have concentrated on extruder dies and preforms of three-fold symmetry, they are equally applicable to other designs by choosing correspondingly appropriate outer wall and/or central core shapes. For example, with four-fold symmetry the outer wall should have a rounded-square cross-section, for two fold-symmetry an oval outer wall will be preferred. Furthermore, if an asymmetric final fibre is required, perhaps to provide a fibre with polarisation dependent losses or birefringence, the pulling effect of the struts could be used advantageously whereby a non-circular outer wall is provided with radial struts which meet it at locations where it is already nearer to the central core.

### Sixth Embodiment

FIG. 19d schematically shows a side view of an inner die part 302 of a die according to a sixth embodiment of the invention. In operation, the inner die part 302 would combine with an outer die part which is not shown, but which would be similar to and understood from the description of the outer die part 104 of the first embodiment. The inner die incorporates two modifications from the design of the first embodiment.

First, the radial flow diversion channels 632 are provided with bridges 629. This adds structural strength to make the die more resistant to being prized apart by the force of the material during extrusion. This is beneficial when extruding higher viscosity glasses, such as gallium lanthanum sulphide (GLS). In this example the channels 632 taper in cross-section towards the output end, but bridges could be used in a non-tapered design, such as in the first embodiment.

Second, the main material feed is through a smooth tapered axial channel 625 until the end where a short straight axial channel 630 is provided. The axial channel 625 narrows gradually without the steps of the previous embodiments. This will assist a smooth increase in the pressure profile in the feed direction. A smooth taper of this kind can be manufactured by spark erosion.

### Further Embodiments

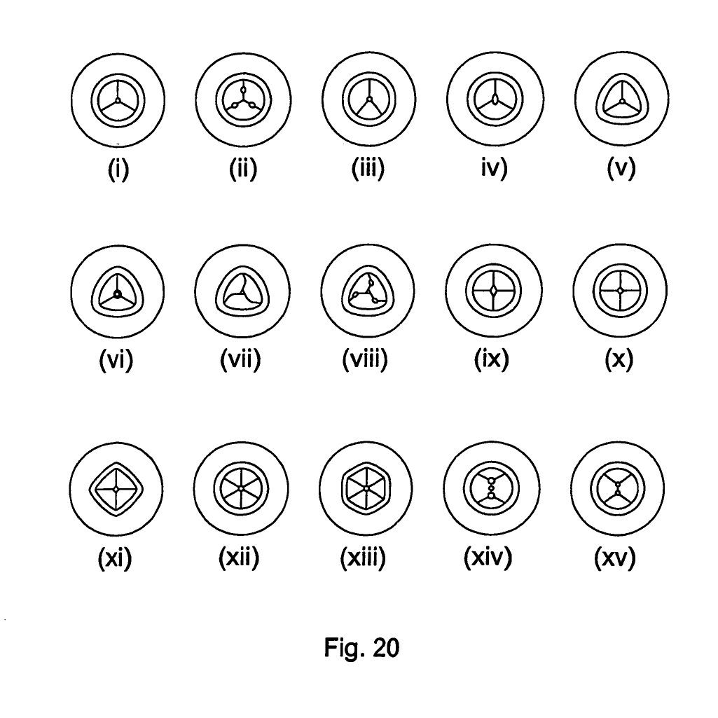

FIG. 20 schematically shows plan views of the lower faces (i.e. those which define the extrusion cross-section) of a plurality of extruder dies according to further embodiments of the invention. As will be understood from the following, the core may have a wide variety of shapes, circular, polygonal etc. and the struts can have a wide variety of lengths and thicknesses, with the thicknesses being substantially constant along the strut radial length in some examples, and of varying thickness in other examples.

The extruder die of FIG. 20i provides a cane preform substantially as described above with reference to the first embodiment of the invention.

The extruder die of FIG. 20ii provides a cane preform with a tubular circular outer wall and three radial struts. Each radial strut supports a cylindrical core displaced from the central cane preform axis.

The extruder die of FIG. 20iii provides a cane preform with a tubular circular outer wall, a solid central core and three radial struts. In this example, the radial struts are not equi-angularly spaced.

The extruder die of FIG. 20iv provides a cane preform with a tubular circular outer wall, a solid central core and three radial struts. In this example, the central core has an asymmetric diamond cross-section

The extruder die of FIG. 20v provides a cane preform with a tubular rounded-triangle outer wall, a solid central core and three radial struts.

The extruder die of FIG. 20vi provides a cane preform with a tubular rounded-triangle outer wall, a central core and three radial struts. In this example, the central core is hollow.

The extruder die of FIG. 20vii provides a cane preform with a tubular rounded-triangle outer wall, a solid central core and three radial struts. In this example, the radial struts are curved and meet the central core at the vertices of its triangular cross-section.

The extruder die of FIG. 20viii provides a cane preform with a tubular rounded-triangle outer wall, a solid central core and three radial struts. In this example, the radial struts are curved and meet the central core at the vertices of its triangular cross-section. Each curved radial strut also supports a cylindrical core displaced from the central cane preform axis.

The extruder die of FIG. 20ix provides a cane preform with a tubular circular outer wall, a solid central core and four radial struts. In this example, the central core has an elongated diamond cross-section.

The extruder die of FIG. 20x provides a cane preform with a tubular circular outer wall, a solid central core and four radial struts.

The extruder die of FIG. 20xi provides a cane preform with a tubular rounded-square outer wall, a solid central core and four radial struts.

The extruder die of FIG. 20xii provides a cane preform with a tubular circular outer wall, a solid central core and six radial struts. In this example, the extruder die has six-fold symmetry.

The extruder die of FIG. 20xiii provides a cane preform with a tubular rounded-hexagon outer wall, a solid central core and six radial struts.

The extruder die of FIG. 20xiv provides a cane preform with a tubular circular outer wall and a solid central core. In this example, the solid central core is suspended by thin struts between two hollow cores, each of which is in turn suspended by two further thin struts to connect them to the wall. These hollow cores could, for example, incorporate electrodes to allow for electrical poling.

The extruder die of FIG. 20xv provides a cane preform with a tubular circular outer wall. In this example, two solid cores are symmetrically disposed about the central axis and are supported by a network of struts.

None of the cross-sectional profiles of cane preforms which could be extruded from the dies shown in FIG. 20 could be made using conventional capillary stacking techniques. There is an essentially limitless range of other profiles which could also be used. Some of these, for example, might incorporate combinations of the features shown in FIG. 20 in different ways. For example, the three off-axis cores provided by the die shown in FIG. 20ii could be combined with the four-fold symmetrical arrangement indicated in FIG. 20x to provide a die for extruding a cane preform with four off-axis cores, with or without a central core.

While the specific details of the geometry of the opening face of the extruder die are different for each of the different cane preform profiles, the die design principles described above are applicable to all. For example, the die design represented in FIG. 20iv would be as described with respect to the first embodiment given above, but with a non-axially symmetric third axial channel opening into the lower face of the die. In the die design shown in FIG. 20ii, the third axial channel of the first embodiment is reduced to a diameter matching the thickness of the lower group of radial channels and so no central core is formed and at the centre of the opening of each of the lower group of radial channels a circular widening in the profile provides for the off axis cores shown in the figure. This widening may persist vertically throughout the radial channels, or may only open up towards the lower face of the die. The multiple cores again comprise un-re-welded glass from the central axis feed and so maintain high optical integrity. In the case of the hollow cores shown in FIG. 20xiv, these may be provided merely to provide ducts for electrode insertion, or may be optically active, for example dimensioned to support a ring mode.

The cane preforms shown in FIGS. 12 and 19c, have been uniformly extruded and display constant transverse cross-sections along their length. In some circumstance, however, a longitudinally varying cane preform may be preferred to provide a drawn fibre in which its properties which vary along its length. The longitudinal non-uniformity can be introduced in several ways. For example, a helical twist could be generated in a cane preform by rotating it about its longitudinal axis during extrusion. A fibre drawn from such a preform would have helically evolving struts and may be used, for example, to control circular birefringence. Helically evolving struts could similarly be introduced at other stages of fibre manufacture, for example, by rotating the cane preform and/or fibre preform during a caning or drawing process. This would allow higher helix pitch angles to be generated into the final fibre. A longitudinal non-uniformity can further be introduced by varying the rate of extrusion, for example by modifying the extrusion pressure or temperature to alter the cane preform core thickness. This can be done in a continuous, cyclical or pulsed manner to respectively create tapered, periodic or discretised longitudinal variations in a final drawn fibre. These variations can also be introduced at other stages of fibre production, for example by varying the rate at which caning or drawing is performed. Such longitudinal structuring can assist in dispersion management, Brillouin suppression, etc.

Materials Considerations

As described in the example above, the extruder die is made from stainless steel grade 303. This die has been used to extrude SF57 glass. The inventors have also successfully extruded a range of other glasses, such as a tellurite glass, and a gallium lanthanum sulphide glass. More generally, the invention is applicable to a wide range of glasses and non-glasses such as polymers from which optical fibres may be made. Further examples may relate to the following glasses:

Lead glasses (e.g. SF57, SF59)

Chalcogenides (e.g. S, Se or Te-based glasses);

Sulphides (e.g. Ge:S, As:S, Ge:Ga:S, Ge:Ga:La:S);

Oxy Sulphides (e.g. Ga:La:O:S);

Halides (e.g. ZBLAN (trade mark), ALF);

Chalcohalides (e.g. Sb:S:Br);

Heavy Metal Oxides (e.g. PbO, ZnO, TeO₂);

Silicates (e.g. silicate, phosphosilicate, germanosilicate); and

Polymers (e.g. polyacrylate, polycarbonate, polystyrene, polypropylene, polyester, PMMA, Cytop (trade mark), Teflon (trade mark)).

Some specific examples are now further detailed.

In the case of a sulphide glass, this may be formed from the sulphides of metals selected from the group: sodium, aluminium, potassium, calcium, gallium, germanium, arsenic, selenium, strontium, yttrium, antimony, indium, zinc, barium, lanthanum, tellurium and tin.

In the case of a glass based on gallium sulphide and lanthanum sulphide, glass modifiers may be used based on at least one of: oxides, halides or sulphides of metals selected from the group: sodium, aluminium, potassium, calcium, gallium, germanium, arsenic, selenium, strontium, yttrium, antimony, indium, zinc, barium, lanthanum, tellurium and tin.

In the case of a halide glass, it may be formed from fluorides of at least one of: zirconium, barium and lanthanum. Further, glass modifiers may be used selected from the fluorides of the group: sodium, aluminium, potassium, calcium, gallium, germanium, arsenic, selenium, strontium, yttrium, antimony, indium, zinc, barium, lanthanum, tellurium and tin.

In the case of a heavy metal oxide glass, the oxides may be selected from: sodium, aluminium, potassium, calcium, gallium, germanium, arsenic, selenium, strontium, yttrium, antimony, indium, zinc, barium, lanthanum, tellurium and tin.

In the case of a heavy metal oxyfluoride glass, the glass may be formed by heavy metal oxides selected from oxides of metals of the group: sodium, aluminium, potassium, calcium, gallium, germanium, arsenic, selenium, strontium, yttrium, antimony, indium, zinc, barium, lanthanum, tellurium and tin and 0-50 mol % total fluoride.

In the case of a heavy metal oxychloride glass, the glass may be formed by heavy metal oxides selected from oxides of metals from the group: sodium, aluminium, potassium, calcium, gallium, germanium, arsenic, selenium, strontium, yttrium, antimony, indium, zinc, barium, lanthanum, tellurium and tin and 0-50 mol % total chloride.

In the case of a heavy metal oxybromide glass, the glass may be formed by heavy metal oxides selected from oxides of metals from the group: sodium, aluminium, potassium, calcium, gallium, germanium, arsenic, selenium, strontium, yttrium, antimony, indium, zinc, barium, lanthanum, tellurium and tin and 0-50 mol % total bromide.

In the case of polymers, the polymer may be PMMA or any poly-x compound, such as polyacrylate, polycarbonate, polystyrene, polypropylene or polyester, with specific commercial examples being Cytop (trade mark) and Teflon (trade mark. Active dopant material such as erbium or other rare earth elements can be incorporated as desired. Hybrid fibres incorporating glass and polymer may also be provided, for example silica in combination with PMMA.

While stainless steel grade 303 may be a suitable extruder die material for the extrusion temperatures and pressures associated with many glasses, in some cases different materials may be more appropriate. For example, if a particular glass requires a higher extrusion temperature and/or pressure, stainless steel grade 303 may not be able to withstand the extrusion process. Other metals, such as tungsten, molybdenum, tantalum, niobium, titanium, or associated alloys, may be required to form an extruder die. Ceramic materials may also be considered for glasses with high melting temperatures, such as silicate glasses.

The structural requirements of the extruder die material for polymer extrusion are likely to be more relaxed. For example, a polymer cane preform similar to those described above could be extruded with an aluminium, or even a plastic, extruder die.

Device Applications

Extruded microstructured optical fibres can possess a much wider range of geometries than conventionally fabricated microstructured fibre and be easily made from a wide range of compound glasses. This makes them particularly well suited to a number of applications and they can be used in a large range of devices, some of which are now outlined below.

(a) Highly non-linear fibre for switching applications: When the higher third order refractive index constant n₂ typical of compound glass materials is combined with the high degree of mode confinement achievable with microstructured fibre, compound glass microstructured fibres could exhibit up to 10000 times the non-linearity of conventional silica fibre. Extremely short fibre based non-linear devices could thus be made for telecom power pulses. For example, the n₂ of SF57 glass is 20 times larger than that of pure silica at 1550 nm, and so a microstructured SF57 fibre will have an effective non-linearity γ that is 20 times larger than its silica equivalent with the same effective mode area, hence in a device, an order of magnitude lower power could be used. Note that such fibres could be used for devices based on self action (in which the properties of a laser beam get modified by the non-linearity at high intensities), or within devices based on cross action (in which the high intensity of one beam (pump beam) is used to modify the properties of a second beam (probe beam)). Specific processes that can be used in such switches include simple Kerr effect induced Self Phase Modulation (SPM), and Cross Phase Modulation (CPM). With certain materials at certain wavelengths it is also possible to envisage using resonant non-linearities such as Two Photon Absorption (TPA) and which will again be enhanced in small core holey fibres.

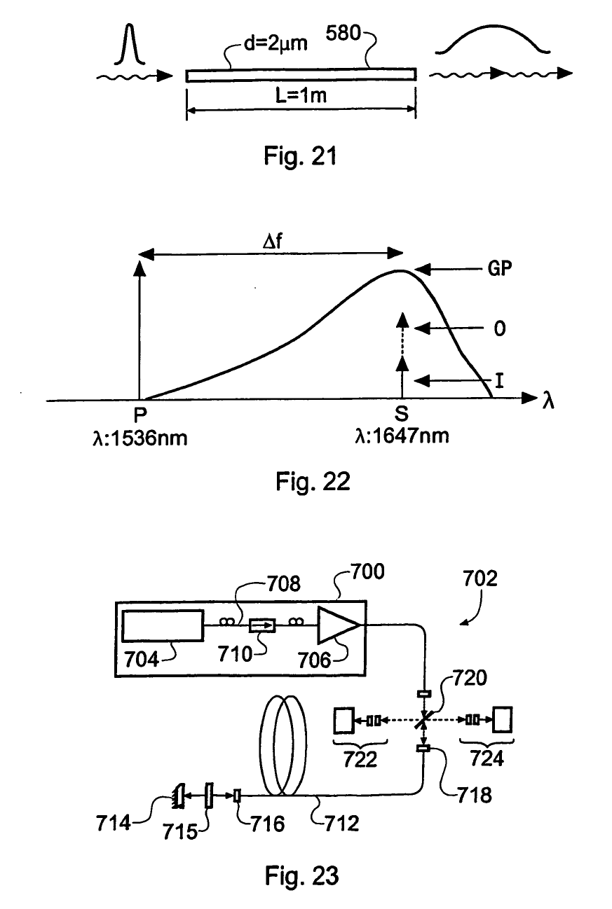

FIG. 21 shows an example non-linear device used for spectral broadening of pulses. For example, consider a compound glass microstructured fibre 580 with a small core diameter of 2 microns, length 1 metre and n₂ of about 100 times that of silica (as for GLS glass). The propagation of an initially transform limited Gaussian pulse of approx. 1.7 W peak power in 1 m of fibre should result in a 10-fold spectral broadening, for example from 1 to 10 nm pulse half width. Alternatively, one can express the above example in terms of a maximal phase shift at the pulse centre i.e. a 1.7 W Gaussian pulse will generate a peak non-linear phase shift of 8.6 radians after propagation through 1 m of fibre. Note that both of the above calculations neglect the effect of fibre dispersion. Dispersion can play a significant role in the non-linear propagation of a short optical pulse and can for example result in effects such as soliton generation. Compound glass fibres offer for example the possibility of soliton formation at wavelengths not possible with conventional silica fibres.

A range of possibilities exist for using these fibres as the basis for a variety of non-linear optical switches. These include Kerr-gate based switches, Sagnac loop mirrors, non-linear amplifying loop mirrors or any other form of silica fibre based non-linear switches (see reference [8], the contents of which is incorporated herein by reference).

One specific example is of a 2R data regenerator based on a short length of small-core microstructured optical fibre. Such a device based on a silica microstructured fibre with an effective core area of approx. 3 μm² at 1550 nm is described in reference [11]. As described above, a short pulse travelling in the highly non-linear fibre undergoes spectral broadening. If a narrowband filter offset from the original central wavelength of the pulse is inserted after the fibre, only spectral components that are generated non-linearity are transmitted. In the implementation described in reference [11], a dielectric filter is used as the filtering element, its central wavelength was offset by 1.9 nm from the pulse, and just 3.3 m of fibre was required. It is possible to envisage using other forms of filter for the offset narrowband filtering function including amongst others; a fibre Bragg grating, acousto-optic tunable filter or Fabry Perot interferometer. In this way, a non-linear thresholder is formed, which passes through and equalises high intensity pulses, and suppresses low-intensity input pulses. Such a device can act as a data regenerator in a telecommunications system. By using a glass with a higher n₂ such as SF57, SF59, tellurite or GLS glass, the figure of merit for this device would be even further improved relative to silica. Note that for many applications of the above form of switch it is advantageous to use a fibre designed to have a normal group velocity dispersion at the operating wavelength since fibre with anomalous dispersion can in certain instances generate additional amplitude noise through soliton based effects. In other forms of switch however, most specifically those employing soliton effects for switching, anomalous dispersion is required.

(b) Raman Devices: The demand for optical data transmission capacity has generated enormous interest in communication bands outside of a conventional erbium doped fibre amplifier (EDFA) gain bandwidth. Fibre amplifiers based on the Raman effect offer an attractive route towards extending the range of accessible amplification bands. In addition to applications in signal amplification, the fast response time (<10 fs) of the Raman effect can also be used for all-optical ultra-fast signal processing applications. One significant drawback to devices based on Raman effects in conventional optical fibres is that long lengths of fibre (˜10 km) are generally required. To obtain adequate gain in a short length of optical fibre it is necessary to use a speciality fibre with either a very high Raman gain coefficient or a small effective mode area Hence microstructured fibres according to the invention are ideal for Raman amplification and modulation devices.

FIG. 22 schematically shows the operational implementation of a specific (pulsed) Raman amplifier by graphically representing the spectral components in wavelength space. The pump source (P) was a 1536 nm diode seeded, fibre amplifier based master oscillator power amplifier (MOPA) configuration, operated in pulsed mode to provide 20 ns square pulse at 500 KHz repetition rate, corresponding to a 100:1 pump duty cycle. Pump and input signal (I) beams are combined using a 1530/1630 nm wavelength division multiplex coupler prior to launching the light into the microstructured fibre Raman amplifier. A continuous wave external cavity tuneable laser was used to provide signal light (I) in the L+ wavelength band (1600-1640 nm). In this particular implementation the microstructured fibre was based on silica glass with a peak Raman shift (Δf) of ˜13 THz. The Raman gain peak (GP) was thus located at 1647 nm superimposed on the background amplified spontaneous emission signal. Higher gain and a lower noise figure are observed as the probe signal wavelength approaches the peak of the Raman gain curve (near 1650 nm). The Raman shifts in other glasses can be substantially different both in terms of gain coefficient, and Raman lineshape. This opens up new possibilities both for amplification bands (e.g. peaked at either longer/shorter wavelength separations from the pump, and with different lineshape relative to silica), and pump wavelengths for a given amplification band, and promises far shorter device lengths/reduced pump powers relative to silica based devices.

The Raman effect can also be used for signal modulation devices. In this instance, a strong pump beam is used to induce loss for a shorter wavelength co-propagating beam. In order to demonstrate this effect we used the same experimental configuration as used for Raman amplification process schematically indicated in FIG. 22, except that the tuneable signal source at around 1600 nm was now replaced with a 1458 nm continuous wave semiconductor diode laser. Strong pump pulses generate a corresponding signal loss due to stimulated Raman scattering (SRS), which results in the formation of ‘dark’ pulses at the signal wavelength, where the signal overlaps the pump pulses.

The Raman effect can also be used to make Raman laser devices (see for example reference [13] for a specific embodiment of a microstructured silica fibre based Raman laser. To construct a Raman laser it is necessary to take a Raman amplifier and to incorporate it within a resonant cavity, often defined as in reference [12] by using Fresnel feedback from the fibre end facets themselves. The use of extruded compound glass microstructured fibres with different Raman gain characteristics should open up possibilities for Raman lasers at new wavelengths, with reduced thresholds (relative to other silica fibre based Raman lasers), and new pump laser choices for specific Raman laser operating wavelengths.

(c) Brillouin laser: Microstructured fibre according to the invention can also be applied to another important class of non-linear fibre-optic devices—devices based on the Brillouin effect. This should include devices based on stimulated Brillouin effects e.g. Brillouin laser and amplifier devices, and devices based on spontaneous Brillouin effects (e.g. distributed temperature/strain sensors).

FIG. 23 schematically represents an example Brillouin laser device 702. The pump source 700 for the microstructured fibre Brillouin laser is based on an erbium fibre distributed feedback (DFB) seed laser 704 coupled to a high power Er/Yb amplifier 706 by a fibre 708 containing an isolator 710. A Fabry-Perot resonator is formed by a 75 m length of microstructured fibre 712, coupled by a lens 716 to a high-reflectivity cavity mirror 714 and by a 96% output coupler defined by the Fresnel reflection from the cleaved fibre facet at the pump launch end of the cavity. Power from the pump source 700 is coupled into the Fabry-Perot resonator via a lens 718. A beam splitter diverts a fraction of the pump beam to a pump monitor 722 and a fraction of the output beam to an output monitor 724. The frequency of the Brillouin laser output was downshifled (in this example by 10.6 GHz) relative to the pump frequency. The small core fibre provides good power conversion efficiency within the Brillouin laser device.

(d) Multicore fibre devices: Microstructured fibres according to the invention may incorporate multiple cores as described above, and such fibres can be used to make a range of practical devices. Some examples include the switching of light between different cores of a multicore fibre, e.g. by detuning/tuning a particular coupling process via a non-linear effects, or through bending or deformation of the fibre as used in a variety of fibre sensing applications.

(e) Devices based on supercontinuum: When small core dimensions are combined with the unusual dispersion properties possible in these novel microstructured fibre designs, it is possible to generate a broad supercontinuum spectrum from a narrowband pulsed source by taking advantage of non-linear processes in the fibre. New frequencies are created most efficiently when the fibre is pumped at or near the zero dispersion wavelength, and the generated supercontinuum can extend from the ultraviolet (UV) (<300 nm) out beyond 1.8 μm, and microstructured fibres can be effectively single mode over this broad wavelength range. Applications of this phenomenon include: new source wavelengths, pulse compression, metrology and spectroscopy. Compound glasses offer some specific advantages for devices based on supercontinuum generation: (1) enhanced non-linearity (via enhanced n₂), resulting in supercontinuum generation at lower pulse energies (2) a wider range of zero dispersion wavelengths in these different materials should allow a wider range of pump sources to be used (3) the enhanced transmission of some compound glasses in the infrared (IR) opens the possibility extending the broadband continuum into the IR.

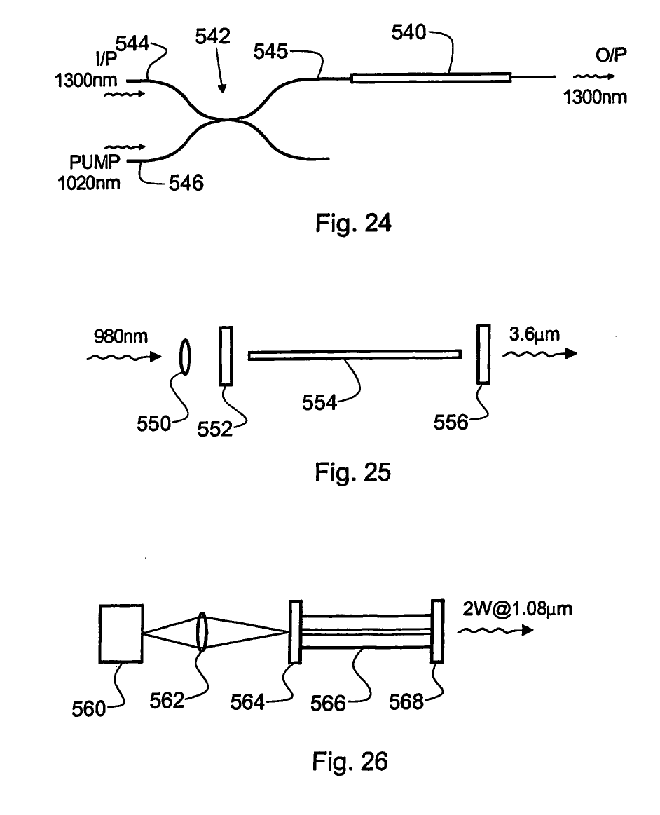

(f) 1300 mm Optical Amplifier/laser: FIG. 24 shows a 1300 nm band rare-earth doped microstructured fibre amplifier incorporating microstructured optical fibre according to the invention. Pump radiation at 1020 nm from a laser diode and a 1300 nm input signal are supplied to fused coupler input arms 544 and 546, and mixed in a fused region 542 of the coupler. A portion of the mixed pump and signal light is supplied by an output arm 545 of the coupler to a section of Pr³⁺-doped gallium lanthanum sulphide microstructured fibre 540 where it is amplified and output. Other rare-earth dopants such as Nd or Dy could also be used with an appropriate choice of pump wavelength.

(g) Infrared Fibre amplifiers/laser: With compound glasses, a wide range of laser transitions become efficient and viable, so compound glass microstructured fibres according to the invention have potential for use as gain media in laser sources. Some examples include using lines at 3.6 and 4.5 microns (Er), 5.1 microns (Nd³⁺), 3.4 microns (Pr³⁺), 4.3 microns (Dy³⁺), etc. More examples for gallium lanthanum sulphide are given in reference [7] which is incorporated herein by reference. These transitions could be exploited in a range of lasers, including continuous wave, Q-switched, and mode-locked lasers and amplifiers. In addition, any of the usual rare-earth dopants could be considered depending on the wavelengths desired.

FIG. 25 shows one example of an infrared fibre laser in the form of a laser having an erbium-doped gallium lanthanum sulphide microstructured fibre gain medium 554 bounded by a cavity defined by a dichroic mirror 552 and output coupler 556. Pump radiation at 980 nm from a laser diode (not shown) is supplied to the cavity through a suitable lens 550. The laser produces a 3.6 micron laser output. It will be appreciated that other forms of cavity mirrors could be used, e.g. in-fibre Bragg grating reflectors. The fibre laser cavity could also be configured in a travelling wave ring geometry.

(h) High-Power Cladding Pumped Lasers and amplifiers: The higher index contrast possible in compound glass microstructured fibres allows for fibres with very high numerical aperture (NA) of well in excess of unity. It is therefore possible to provide improved pump confinement and thus tighter focusing, shorter devices, lower thresholds etc.

FIG. 26 shows one example in the form of a cladding pumped laser having a lead glass microstructured fibre such as SF57 gain medium 566 doped with Nd. A pump source is provided in the form of a high-power broad-stripe diode 560 of 10 W total output power at 815 nm. The pump source is coupled into the gain medium through a focusing lens 562 and the cavity is formed by a dichroic mirror 564 and output coupler 568 to provide high-power, multiwatt laser output at 1.08 microns.

(i) Evanescent Field Devices: The guided mode can be made to have significant overlap with gas or liquid present in the holes, so that fibres can be used to measure gas concentrations, for example. A particular advantage of compound glass microstructured fibres is that longer wavelengths can be used, which would allow a much wider range of gases to be detected. The mid-infrared (3-5 microns) part of the spectrum is of particular interest.

Working at these longer wavelengths should also significantly ease the fabrication requirements associated with making microstructured fibres that are suitable for evanescent field devices, simply because the size of the structure that is required scales with the wavelength.

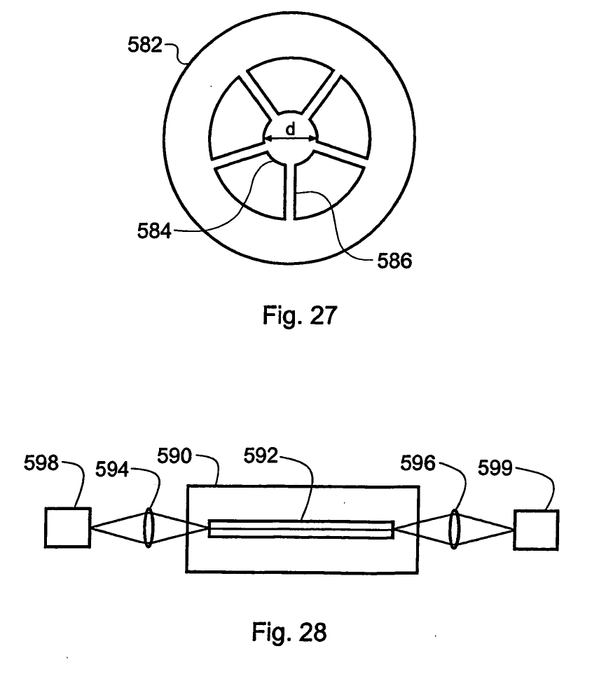

FIG. 27 shows a transverse section of an example glass microstructured fibre according to the invention for gas sensing. Large holes 586 in the cladding are provided by radially extending strut structures extending between a solid core 584 and outer wall 582. The core diameter ‘d’ is preferably much less than the operating wavelength ‘λ’ to ensure that a significant fraction of the mode power lies in the microstructured region. For example, for 5 micron operation a core diameter of 2 microns could be used.

FIG. 28 shows a sensing device including a gallium lanthanum sulphide microstructured fibre 592 having a structure as shown in FIG. 25. The gallium lanthanum sulphide microstructured fibre 592 is arranged in a gas container 590, containing CO₂ gas, for example. A light source 598 is arranged to couple light into the gallium lanthanum sulphide microstructured fibre 592 via a coupling lens 594 through a window in the gas container. Light is coupled out of the gas container through a further lens 596 and to a detector 599. The detector will register presence of a particular gas through an absorption measurement of the light (for example, absorption of light at 4.2 microns for the detection of CO₂). Tellurite glasses also offer transmission further into the infrared than silica fibres, and so similar devices based on tellurite glasses could be envisaged.

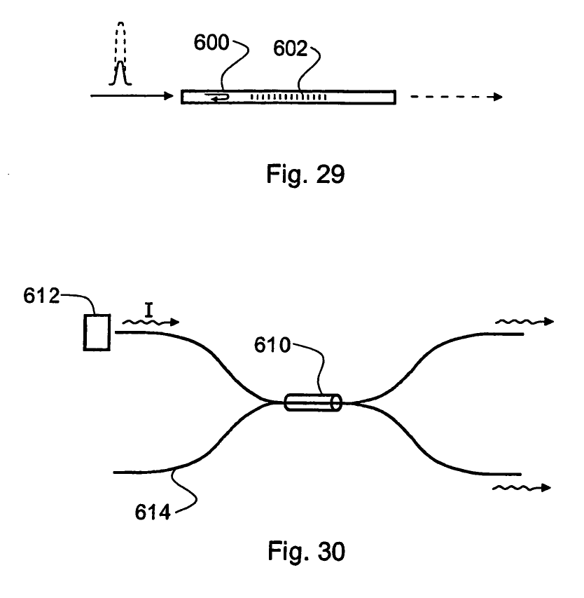

(j) Non-linear grating based devices: The high non-linearity fibre manufacturable with the invention should allow for low threshold grating based devices (logic gates, pulse compressor and generators, switches etc.). For example, FIG. 29 shows an optical switch based on gallium lanthanum sulphide microstructured fibre 600 made with a small core diameter of around 1-2 microns and incorporating an optically written grating 602. In operation, pulses at low power (solid lines in the figure) are reflected from the grating, whereas higher power pulses (dashed lines in the figure) are transmitted due to detuning of the grating band gap through Kerr non-linearity.

(k) Acoustic Devices: More efficient microstructured fibre acousto-optic (AO) devices can be fabricated. The acoustic figure of merit in compound glasses is expected to be as much as 100-1000 times that of silica This opens the possibility of more efficient fibre AO devices such as AO-frequency shifters, switches etc. Passive stabilisation of pulsed lasers may also be provided. Microstructured fibres might also allow resonant enhancements for AO devices via matching of the scale of structural features to a fundamental/harmonic of the relevant acoustic modes. The use of compound glass materials would also allow AO devices to be extended to the infrared.

FIG. 30 shows an AO device in the form of a null coupler based on gallium lanthanum sulphide microstructured fibre. The device has the form of a null coupler 614 with a coupling region at which a piezoelectric transducer 610 is arranged for generating acoustic waves. In the absence of an acoustic wave, light I is coupled from a source 612 into one output arm of the coupler (solid line), whereas in the presence of the acoustic wave light is coupled into the other output of the coupler (dashed line). Further details of devices of this kind can be found in references [9] and [10].

(l) Highly non-linear fibre for second harmonic generation (SHG): The higher third order refractive index constant n₂ typical of compound glass materials can be combined with the high degree of mode confinement achievable with microstructured fibres according to the invention to provide up to 10000 times the effective non-linearity of conventional silica fibre. Efficient short fibre based non-linear devices could thus be made based on third order effects. In materials, such as glass and many polymers, inversion symmetry at the molecular level means that the material and indeed any fibre made of such materials cannot possess a second order non-linearity. However, within certain materials, most notably certain polymers, and glasses, it is possible to use poling techniques to induce a large, permanent, “frozen in” DC electric field within the material. This internal DC electric field in combination with the third order non-linearity can then give rise to large values of effective second order non-linearity. It is possible to pole the material within the core of an optical fibre. Moreover, it is possible to create periodically poled sections of fibre along the fibres length so as to create a second order non-linearity grating. The pitch of this grating can be tailored so to phase-match a specific non-linear process between three optical fields propagating within the fibre. This form of phase matching employing periodically poled regions of non-linearity is generally referred to as quasi-phase matching. Specific non-linear processes that can be phase matched include second harmonic generation, and both sum and frequency difference generation.

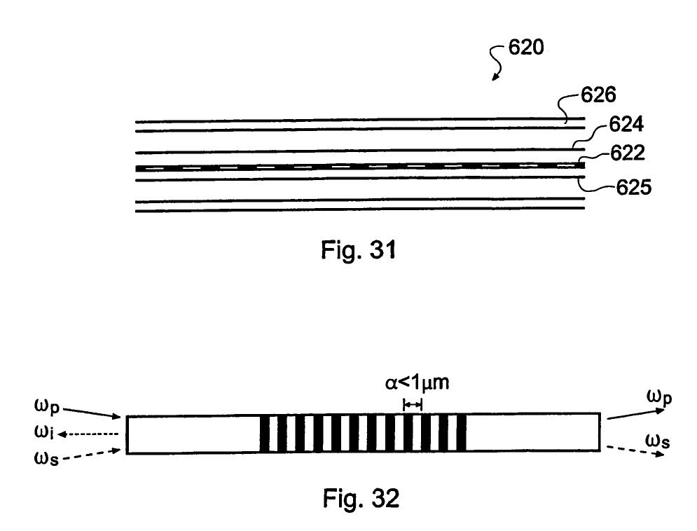

FIG. 31 shows a schematic longitudinal axial section through a microstructured optical fibre 620 fabricated from a preform extruded from the die shown in FIG. 20xiv for use in a forward-interaction second harmonic generator (SHG) device. The periodically poled second-order non-linearity in the core 622 is shown schematically by black and white striping in the figure. The poling electrodes 624, 625 are formed within the drawn hollow cores of the cane preform. The drawn outer wall 626 of the preform is also shown.

(m) Highly non-linear fibre for three wave mixing (TWM): FIG. 32 shows a backward TWM fibre device that provides a transparent and effective frequency converter, which would be largely employed in Wavelength-Division-Multiplexing (WDM) optical telecommunication systems. The pump beam interacting with the non-linear microstructured fibre and with the incoming signal, produces a backward travelling idler which carries the same modulation as the signal at a different wavelength such that: ωᵢ+ωₛ=ωₚ where ωᵢ, ωₛ, ωₚ are used to denote idler, signal and pump frequency respectively. The phase-matching condition is provided by the use of a periodic non-linearity achieved in the core by conventional thermal poling, it is noted that the period a required for the poling is much smaller than for forward-interaction devices, typically of the order of a micron or less, so that use of a phase mask, rather than an amplitude mask, may be preferred for the poling. The small poling period is needed in order to compensate for the large momentum mismatch between the counter-propagating waves.

An advantage of backward interaction is the separation between the signal and the idler and pump, which occurs naturally. A wavelength converter based on such a device would not therefore require any further optical filtering to separate the desired wavelength (idler) from the residual ones (pump and signal).

Another application of backward-interaction TWM is for the implementation of mirror-less optical parametric oscillators, where the optical feedback required in order to start the oscillation is provided by the backward propagation of the waves inside the non-linear fibre.

(n) Highly non-linear fibre for Four-Wave-Mixing WM) processes: The higher third order refractive index constant n₂ typical of compound glass materials can be combined with the high degree of mode confinement achievable with microstructured fibres according to the invention to provide up to 10000 times the effective non-linearity of conventional silica fibre. Efficient short fibre based non-linear devices should thus be possible based on 4-wave mixing. In order to achieve efficient 4-wave mixing processes in fibre one need to ensure both (a) energy conservation, and (b) phase matching (momentum conservation), for the photons involved in the specific desired process. Phase matching can be achieved in a variety of ways within a fibre for example between four photons in a single fundamental polarisation mode of the fibre, between photons in different polarisation/spatial modes, between photons in the fundamental and higher order transverse modes, and between photons exclusively in higher order transverse modes of the fibre. The linear properties of the waveguide e.g. group velocity, group velocity dispersion, birefringence and modal overlap of the fundamental and higher-order modes of the structure thus play a critical role in defining which specific non-linear processes can be efficient in a given fibre. Each of these properties can be tailored to a greater extent in microstructured fibres than in conventional fibres allowing for an increased range of phase-matching possibilities, and therefore an increased range of efficient non-linear four wave mixing processes. Obviously the higher non-linear coefficient of materials such as compound glass can greatly reduce the powers required to make a given phase-matched process efficient. Specific four wave mixing processes involving the generation of photons at different frequencies include: Third Harmonic Generation (THG), degenerate 4-wave mixing (parametric amplification and lasing), non-degenerate four wave mixing, and modulational instability. Such processes can be used as the basis of a variety optical devices, including amongst others devices for wavelength conversion, optical switching, amplification (and lasing), demultiplexing, phase conjugation and dispersion compensation of an incoming laser beam/signal.

Many other devices can incorporate microstructured optical fibre according to the invention. The above examples are merely illustrative.

### REFERENCES

[1] Maxwell: Euro Photonics, December/January 2002, pages 24-25 (see page 25, left hand column]
[2] Kaiser & Astle: The Bell System Technical Journal: vol. 53, no. 6 (1974), pages 1021-1039
[3] Roeder & Egel-Hess: Glasstech. Ber. vol. 60 (1987) No. 5, pages 177-181
[4] Schott Optical Glass Catelog
[5] G. P. Agrawal, Nonlinear Fibre Optics (Academic Press, San Diego, 1995).
[6] T. M. Monro, D. J. Richardson, N. G. R. Broderick, P. J. Bennett, ‘Holey optical fibres: an efficient modal model’, J Lightwave Technol. 17, 1093-1102 (1999).
[7] U.S. Pat. No. 5,822,479
[8] G. Agrawal, Nonlinear Fibre Optics, Academic Press (1995)
[9] T. A. Birks, S. G. Farwell, P. St. J. Russell & C. N. Pannell Four-Port Fibre Frequency-Shifter with a Null Taper Coupler Opt. Lett. Vol. 19(23) pp. 1964-1966 December 1994
[10] S. H. Yun, D. J. Richardson, D. O. Culverhouse and T. A. Birks All-fibre acousto-optic filter with low polarization sensitivity and no frequency shift IEEE Phot. Tech. Lett. 1997 Vol. 9(4) pp. 461-453)
[11] P. Petropoulous, T. M. Monro, W. Belardi, K. Furusawa, J. H. Lee and D. J. Richardson, ‘2R-regenerative all-optical switch based on a highly nonlinear holey fibre’, Opt. Lett. 26, 1233-1235 (2001).
[12] J. H. Lee, Z. Yusoff, W. Belardi, T. M. Monro, P. C. Teh and D. J. Richardson, ‘A holey fibre Raman amplifier and all-optical modulator’, ECOC 2001 Amsterdam 30 Sep.-4 Oct. 2001 PDA 1.1.
[13] J. Nilsson, R. Selvas, W. Belardi, J. H. Lee, Z. Yusoff, T. M. Monro, D. J. Richardson, K. D. Park, P. H. Kim, N. Park “Continuous-wave pumped holey fiber Raman laser” OFC 2002, Anaheim 17-22 Mar. 2002 paper WR6
   The above references are incorporated herein by reference in their entirety.

1. An extruder die for forming a preform for manufacture into an optical fiber, comprising:
a central feed channel for receiving a material supply by pressure-induced fluid flow;
flow diversion channels arranged to divert a first component of the material radially outwards into a welding chamber formed within the die;
a core forming conduit arranged to receive a second component of the material from the central feed channel that has continued its onward flow; and
a nozzle having an outer part in flow communication with the welding chamber and an inner part in flow communication with the core forming conduit, to respectively define an outer wall and core of the preform.

2. An extruder die according to claim 1, wherein the die is provided with pairs of mutually facing internal walls that form gaps extending between the core forming conduit and the welding chamber and allow fluid communication therebetween, the gaps being shaped to form struts supporting the core in the outer wall.

3. An extruder die according to claim 2, wherein the mutually facing internal walls incorporate at least one bend in order to increase the radial length of the struts.

4. An extruder die according to claim 2, wherein the internal walls have a radial length greater than the gap width.

5. An extruder die according to claim 4, wherein the radial length of the internal walls is greater than the gap width by a factor of one of: 2, 3, 4, 5, 6, 7, 8, 9, 10 and 20.

6. An extruder die according to claim 1, wherein the outer part of the nozzle is shaped to provide a circular-section preform outer wall.

7. An extruder die according to claim 1, wherein the outer part of the nozzle deviates from a circular shape so as to provide sections of preform wall interconnecting wall-to-strut junctions that are shorter than would be required to form a circular-section preform outer wall.

8. An extruder die according to claim 1, wherein the outer part of the nozzle has a first dimension defining a wall thickness of the preform outer wall and wherein said first dimension is greater than said gap between the mutually facing internal walls that form the preform struts.

9. An extruder die according to claim 8, wherein said first dimension is greater than said gap by a factor of one of: 2, 3, 4, 5, 6, 7, 8, 9 and 10.

10. An extruder die according claim 1, wherein the inner part of the nozzle has a second dimension defining a core thickness of the preform core and wherein said second dimension is greater than said gap between the mutually facing internal walls that form the preform struts.

11. An extruder die according to claim 10, wherein said second dimension is greater than said gap by a factor of one of: 2, 3, 4, 5, 6, 7, 8, 9 and 10.

12. An extruder die according to claim 1, wherein the flow diversion channels include a first group of the flow diversion channels which extend from the core forming conduit to the welding chamber.

13. An extruder die according to claim 12, wherein the flow diversion channels of the first group extend perpendicular to the core forming conduit.

14. An extruder die according to claim 12, wherein the flow diversion channels of the first group have a width dimension that is substantially constant in the feed direction.

15. An extruder die according to claim 12, wherein the flow diversion channels of the first group have a width dimension that reduces in the feed direction.

16. An extruder die according to claim 1, wherein the flow diversion channels include a second group of the flow diversion channels that extend from the central feed channel to the welding chamber.

17. An extruder die according to claim 16, wherein the flow diversion channels of the second group extend obliquely to the central feed channel.

18. An extruder die according to claim 1, further comprising a mandrel extending down the central feed channel into the core forming conduit with a dependent peg thereof so as to form a hollow core in the preform.

19. An extruder apparatus including a main body having a location for receiving an extruder die according to claim 1, a space for arranging a billet of material above the extruder die and a force transmitting assembly for applying pressure to the billet to drive the material through the extruder die.

20. A method of forming a preform for manufacture into an optical fiber, comprising:
applying pressure to supply a material into a central feed channel of an extruder die by pressure-induced fluid flow;
diverting a first component of the material radially outwards into a welding chamber formed within the die;
allowing a second component of the material to flow onwards from the central feed channel into a core forming conduit in the die; and
dispensing the material through a nozzle having an outer part in flow communication with the welding chamber and an inner part in flow communication with the core forming conduit, to respectively define an outer wall and core of the preform.

21. A method according to claim 20, wherein the extruder die is provided with pairs of mutually facing internal walls that form gaps extending between the core forming conduit and the welding chamber and allow fluid communication therebetween, the gaps being shaped to form struts supporting the core in the outer wall.

22. A method according to claim 21, wherein the mutually facing internal walls incorporate at least one bend in order to increase the radial length of the struts.

23. A method according to claim 20, wherein the internal walls have a radial length greater than the gap width.

24. A method according to claim 23, wherein the radial length of the internal walls is greater than the gap width by a factor of one of: 2, 3, 4, 5, 6, 7, 8, 9, 10 and 20.

25. A method according to claim 20, wherein the outer part of the nozzle is shaped to provide a circular-section preform outer wall.

26. A method according to claim 20, wherein the outer part of the nozzle deviates from a circular shape so as to provide sections of preform wall interconnecting wall-to-strut junctions that are shorter than would be required to form a circular-section preform outer wall.

27. A method according to claim 20, wherein the outer part of the nozzle has a first dimension defining a wall thickness of the preform outer wall and wherein said first dimension is greater than said gap between the mutually facing internal walls that form the preform struts.

28. A method according to claim 27, wherein said first dimension is greater than said gap by a factor of one of: 2, 3, 4, 5, 6, 7, 8, 9 and 10.

29. A method according to claim 20, wherein the inner part of the nozzle has a second dimension defining a core thickness of the preform core and wherein said second dimension is greater than said gap between the mutually facing internal walls that form the preform struts.

30. A method according to claim 29, wherein said second dimension is greater than said gap by a factor of one of: 2, 3, 4, 5, 6, 7, 8, 9 and 10.

31. A method according to claim 20, wherein the flow diversion channels include a first group of the flow diversion channels which extend from the core forming conduit to the welding chamber.

32. A method according to claim 31, wherein the flow diversion channels of the first group extend perpendicular to the core forming conduit.

33. A method according to claim 31, wherein the flow diversion channels of the first group have a width dimension that is substantially constant in the feed direction.

34. A method according to claim 31, wherein the flow diversion channels of the first group have a width dimension that tapers down in the feed direction.

35. A method according to claim 20, wherein the flow diversion channels include a second group of the flow diversion channels which extend from the central feed channel to the welding chamber.

36. A method according to claim 35, wherein the flow diversion channels of the second group extend obliquely to the central feed channel.

37. A method according to claim 20, wherein the extruder die further comprises a mandrel extending down the central feed channel into the core forming conduit with a dependent peg thereof so as to form a hollow core in the preform.

38. A method according to claim 20, wherein the material supplied to the central feed channel is a glass.

39. A method according to claim 20, wherein the material supplied to the central feed channel is a polymer.

40. A method of manufacturing an optical fiber comprising: forming a preform by extrusion according to the method of claim 20; and reducing the preform to an optical fiber.

41. A method according to claim 40, wherein reducing the preform to an optical fiber comprises reducing the preform to a cane followed by reducing the cane to the optical fiber.

42. A method according to claim 41, wherein reducing the cane comprises arranging the cane in a tubular jacket and reducing the cane and tubular jacket into the optical fiber.

43. A method according to claim 41, wherein reducing the cane comprises arranging the cane amongst a plurality of rods and/or tubes to form a stack and reducing the stack into the optical fiber.

44. A preform for manufacture into an optical fiber made using the method of claim 20.

45. An optical fiber made using the method of claim 40.

46. A preform for manufacture into an optical fiber, comprising a core suspended in an outer wall by a plurality of struts.

47. A preform according to claim 46, wherein the struts have a width dimension smaller than a width dimension of at least one of the outer wall and the core by a factor of at least two.

48. A preform according to claim 47, wherein the factor is at least one of 3,4,5,6,7,8,9 and 10.

49. A preform according to claim 46, wherein the struts incorporate at least one bend in order to increase their radial length.

50. A preform according to claim 46, wherein the wall as viewed in cross-section deviates from a circular shape so as to provide wall sections interconnecting wall-to-strut junctions that are shorter than would be required to form a circular-section outer wall.

51. A preform according to claim 46, wherein the core has a thickness that varies along its axial extent.

52. A preform according to claim 46, wherein the struts extend helically.

53. A preform according to claim 46 including at least one further core.

54. A preform according to claim 46 including at least one integral electrode.

55. A preform according to claim 46, wherein the struts have a width and a radial length and the radial length is greater than the width.

56. A preform according to claim 55, wherein the radial length of the struts is greater than the width by a factor of one of: 2, 3, 4, 5, 6, 7, 8, 9, 10 and 20.

57. A preform according to claim 46, made of a glass material.

58. A preform according to claim 46, made of a polymer material.

59. A preform according to claim 46, wherein the core is hollow.

60. An optical fiber comprising a core suspended in an outer wall by a plurality of struts.

61. An optical fiber according to claim 60, wherein the struts have a width dimension smaller than a width dimension of at least one of the outer wall and the core by a factor of at least two.

62. An optical fiber according to claim 61, wherein the factor is at least one of 3, 4, 5, 6, 7, 8, 9 and 10.

63. An optical fiber according to claim 60, wherein the core has a thickness that varies along its axial extent.

64. An optical fiber according to claim 60 including at least one further core.

65. An optical fiber preform according to claim 60, wherein the struts extend helically.

66. An optical fiber according to claim 60 including at least one integral electrode.

67. An optical fiber according to claim 60, wherein the struts have a radial length greater than at least one of 2, 3, 4, 5, 6, 7, 8, 9, 10, 12, 14, 16, 18 and 20 micrometers.

68. An optical fiber according to claim 67, wherein the struts have a width smaller than the radial length of the struts by a factor of at least one of 2, 3, 4, 5, 6, 7, 8, 9, 10, 12, 14, 16, 18 and 20.

69. An optical fiber according to claim 60, made of a glass material.

70. An optical fiber according to claim 60, made of a polymer material.

71. An optical fiber according to claim 60, having a core width of greater than at least one of: 0.3, 0.5, 1, 2, 3, 4, 5, 6, 7, 8, 9, 10, 12, 14, 16, 18 and 20 micrometers.

72. An optical fiber according to claim 60, wherein the core is hollow.

73. A method of manufacturing a microstructured optical fiber comprising:
forming by extrusion a preform comprising a core suspended in an outer wall by a plurality of struts; and
reducing the preform into an optical fiber.

74. A laser, amplifier, non-linear device, switch, acousto-optic, sensor or other optical device comprising optical fiber according to claim 60.
